(19) United States
(12) Patent Application Publication
(10) Pub. No.: US 2009/0311484 A1
(43) Pub. Date: Dec. 17, 2009

(54) Molecular Resist Compositions, Methods of Patterning Substrates Using the Compositions and Process Products Prepared Therefrom

(75) Inventors: Joseph M. MCLELLAN, Somerville, MA (US); Brian T. Mayers, Somerville, MA (US); Karan Chauhan, Punjab (IN); Wajeeh Saadi, Cambridge, MA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Nano Terra Inc., Cambridge, MA (US)

(21) Appl. No.: 12/436,436

(22) Filed: May 6, 2009

Related U.S. Application Data
(60) Provisional application No. 61/050,669, filed on May 6, 2008.

(51) Int. Cl. B32B 3/10; C09K 3/00; B44C 1/22

(52) U.S. Cl. 428/172; 252/182.29; 252/182.3; 252/182.12; 216/43; 428/195.1

(57) ABSTRACT

The present invention is directed to molecular resist compositions comprising an organic amine, methods of forming features on substrates using the molecular resists compositions and process products prepared therefrom.

### CROSS-REFERENCE TO RELATED APPLICATIONS

This application claims the benefit of the filing date of U.S. Application No. 61/050,669, filed May 6, 2009, which is incorporated herein by reference in its entirety.

### BACKGROUND OF THE INVENTION

1. Field of the Invention

The present invention is directed to molecular resist compositions, methods for patterning a substrate using the molecular resist compositions and products formed by the processes.

2. Background

Methods of patterning surfaces are well known and include photolithography techniques, as well as the more recently developed soft-contact printing techniques such as microcontact printing (see e.g., U.S. Pat. No. 5,512,131). In microcontact printing, a self-assembled monolayer (“SAM”) is deposited on a substrate using a flexible stamp. SAM patterns having lateral dimensions as small as 40 nm have been prepared. The SAM can be used as a resist for forming a feature on a substrate, for example, by etching a portion of the substrate not covered by the SAM. However, SAMs are not particularly stable, and are known to exhibit pinholes and other defects due to incomplete monolayer coverage. And even when a dense monolayer is produced, most SAMs do not provide sufficient resistance to a wide range of etchants to be widely useful in commercial manufacturing processes.

Photolithography processes employ a polymeric resist that can be patterned using light. While photolithographic resists are more stable and provide better resistance to a variety of etchants compared to SAMs, photolithography requires specialized equipment and chemicals and is typically limited to flat substrates.

What is needed is a low-cost method for patterning substrates with an etch resist that can achieve lateral dimensions below 500 μm, and which is applicable to a wide variety of substrates, etchants, and geometries.

### BRIEF SUMMARY OF THE INVENTION

The present invention is directed to methods for patterning substrates using molecular resists for forming features on the substrates. Features formed by the method of the present invention have lateral dimensions less than 500 μm, and permit all varieties of surfaces to be patterned in a cost-effective, efficient, and reproducible manner.

In some embodiments, the present invention is directed to a method for patterning a substrate, the method comprising: disposing on a substrate a molecular resist composition comprising an organic amine,

wherein the organic amine adheres to the substrate by a non-covalent interaction in a

pattern having at least one lateral dimension of about 500 μm or less; and reacting a portion of the substrate not covered by the pattern to form a feature thereon,

wherein the feature has a lateral dimension defined by the pattern.

In some embodiments, the method further comprises prior to the disposing, forming a primary pattern on an area of the substrate, wherein the primary pattern defines the at least one lateral dimension of the pattern.

In some embodiments, the primary pattern comprises a SAM-forming species.

In some embodiments, the forming comprises contacting the substrate with a stamp having a surface including at least one indentation therein, and wherein the contacting transfers a SAM-forming species from the surface of the stamp to the substrate to form a primary pattern thereon having a lateral dimension defined by the at least one indentation.

In some embodiments, the reacting comprises etching.

The present invention is also direct to a method for patterning a substrate, the method comprising:
contacting a substrate with a stamp having a surface including at least one indentation therein to provide a first pattern on the substrate defined by the at least one indentation;
disposing on the substrate a molecular resist composition comprising an organic amine, wherein the organic amine adheres by a non-covalent interaction to an area of the substrate not covered by the first pattern; and
etching the area of the substrate covered by the first pattern to form a feature thereon.

The present invention is also directed to products of the above processes.

In some embodiments, the pattern has an elevation of about 5 nm to about 5 μm.

In some embodiments, the molecular resist composition further comprises a solvent.

In some embodiments, the solvent comprises a first solvent having a boiling point less than 100° C. and at least one second solvent having a boiling point of 100° C. or greater.

In some embodiments, the substrate comprises a metal surface. In some embodiments, the substrate is a composite substrate comprising a metal surface layer over a material chosen from: a glass, a plastic, a ceramic, a polymer, a second metal, and combinations thereof.

While the patterning of methods of the present invention are generally suitable for use with any molecular resist composition comprising an organic amine, in some embodiments the present invention is also directed to a molecular resist composition consisting essentially of:
an organic amine in a concentration of about 0.01% to about 5% by weight;
a first solvent having a boiling point less than 100° C. in a concentration of about 80% by weight or greater;
at least one second solvent having a boiling point of 100° C. or greater in a concentration of about 15% by weight or less; and
an optional surfactant or stabilizer.

The present invention is also directed to a composition comprising: a substrate having a surface, and on the surface:
(a) a pattern comprising an organic amine, wherein the pattern has at least one lateral dimension of about 500 μm or less; and
(b) adjacent to the pattern, and covering the area of the surface not covered by the pattern, a thin film comprising a SAM-forming species.

The present invention is also directed to a composition comprising: a substrate having a surface including at least one etched indentation therein, the etched indentation forming a pattern in the surface having at least one lateral dimension of about 500 μm or less, and having on the raised areas of the pattern a thin film comprising an organic amine adhered to the substrate by a non-covalent interaction, wherein the etched indentation is free from the organic amine.

In some embodiments, the pattern or thin film comprising an organic amine has a thickness of about 5 nm to about 5 μm. In some embodiments, the pattern or thin film comprising an organic amine does not penetrate or permeate into the substrate.

In some embodiments, the organic amine has a molar absorptivity of about 5,000 M⁻¹ cm⁻¹ or greater for at least one wavelength in the range of about 300 nm to about 900 nm.

In some embodiments, the molecular resist composition is free from any component having a molecular weight of about 2,000 Da or greater.

In some embodiments, the organic amine has the structure of Formula I:

A-(B)ₘ-C I

or a salt thereof, wherein:
A and C are independently chosen from: optionally substituted cycloalkyl, optionally substituted aryl, and optionally substituted heterocyclyl, or A and C are optionally joined to form a macrocyclic ring;
A and C each include at least one double bond;
B is an optionally substituted bridging group or a chemical bond;
m is an integer from 1 to 3, and
the organic amine of Formula I includes at least one amine group attached to at least one of A, B, or C, or an optional substituent thereof.

In some embodiments, the organic amine has the structure of Formula II:

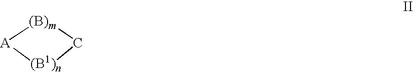

or a salt thereof, wherein:
A and C are independently chosen from: optionally substituted cycloalkyl, optionally substituted aryl, and optionally substituted heterocyclyl, or A and C are optionally joined to form a macrocyclic ring;
A and C each include at least one double bond;
B and B¹ are independently an optionally substituted bridging group or a chemical bond;
m and n are independently an integer from 1 to 3, and
the organic amine of Formula II includes at least one amine group attached to at least one of A, B, B¹, C, or an optional substituent thereof.

In some embodiments, the organic amine has the structure of Formula V:

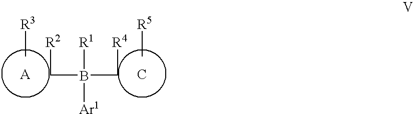

or a salt thereof, wherein:
ring systems A and C are independently a 4- to 14-membered ring system chosen from: optionally substituted cycloalkyl, optionally substituted aryl, and optionally substituted heterocyclyl;
B is an optionally substituted bridging group;
R¹ is optionally absent; or
R¹ and R³ or R¹ and R⁵ are hydrogen or are optionally joined to form a 4- to 7-membered ring system chosen from: optionally substituted cycloalkyl, optionally substituted aryl, and optionally substituted heterocyclyl;
R¹ and R² or R¹ and R⁴ are independently hydrogen, or are optionally joined to form a double bond; or
R² is optionally joined with a member of ring A to form a double bond or a bridging group, or R² is optionally absent;
R⁴ is optionally joined with a member of ring C to form a double bond or a bridging group, or R⁴ is optionally absent;
Ar¹ is chosen from phenyl, naphthyl or aromatic heterocyclyl, any of which is optionally substituted; and
the organic amine of Formula V includes at least one amine group attached to at least one of Ar¹, R¹, R², R³, R⁴, R⁵, ring system A, ring system C, and B, or an optional substituent thereof

In some embodiments, the organic amine has the structure of Formula VI:

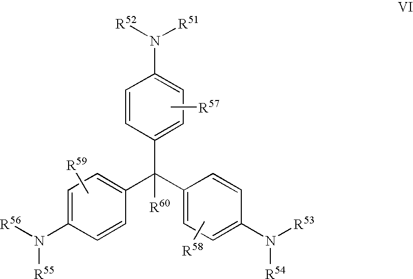

or a salt thereof, wherein:
R⁵¹, R⁵², R⁵³, R⁵⁴, R⁵⁵ and R⁵⁶ are independently hydrogen or C₁-C₄ alkyl;
R⁵⁷, R⁵⁸ and R⁵⁹ are independently hydrogen or methyl; and
R⁶⁰ is hydrogen or C₁-C₆ alkyl.

In some embodiments, the organic amine has the structure of Formula VII:

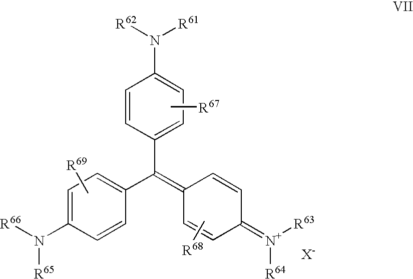

or a salt thereof, wherein:
R⁶¹, R⁶², R⁶³, R⁶⁴, R⁶⁵ and R⁶⁶ are independently hydrogen or C₁-C₄ alkyl;
R⁶⁷, R⁶⁸ and R⁶⁹ are independently hydrogen or methyl; and
X⁻ is a monovalent anion.

In some embodiments, the organic amine is a compound chosen from: acid blue 25, acid blue 29, acid blue 40, acid blue 45, acid blue 80, acid blue 92, acid blue 119, acid blue 120, acid blue 129, acid black 24, acid black 48, acid fuchsin, basic fuchsin, new fuchsin, acid green 25, acid green 27, acid orange 8, acid orange 51, acid orange 63, acid orange 74, acid red 1, acid red 4, acid red 8, acid red 37, acid red 88, acid red 97, acid red 114, acid red 151, acid red 183, acid red 183, methyl violet, methyl violet B, methyl violet 2B, ethyl violet, acid violet, acid violet 1, acid violet 5, acid violet 6, acid violet 7, acid violet 9, acid violet 17, acid violet 20, acid violet 30, acid violet 34, acid alizarin violet N, acid yellow 14, acid yellow 17, acid yellow 25, acid yellow 42, acid yellow 76, acid yellow 99, basic violet 1, basic violet 3, benzyl violet 4B, Coomassie® violet R200, crystal violet, leucocrystal violet, resorcin crystal violet, crystal violet lactone, direct violet 17, direct violet 38, direct violet 51, fast violet B, gentian violet, pararosaniline base, cresolphthalein complexone, cresyl violet acetate, cresyl violet perchlorate, cresyl violet perchlorate, iodonitrotetrazolium violet-formazan, methylene violet 3RAX, pyoktanin blue, pyrocatechol violet, remazol brilliant violet 5R, rhodamine B, tetrazolium violet, violamine R, fast red violet 1B base, iodonitrotetrazolium chloride, leuco patent blue violet, thionin acetate, calcomine violet N, disperse violet 13, disperse violet 17, disperse violet 28, phenol violet, pontachrome violet SW, reactive violet 5, vat violet 1, wool violet, erio chrome violet 5B, omega chrome dark violet D, leucomalachite green, and salts and ionomers thereof, and combinations thereof

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A, 1B, 1C, 1D, 1E, 1F and 1G provide schematic cross-sectional representations of features prepared by the methods of the present invention.

FIG. 2 provides a schematic cross-sectional representation of a curved substrate having features thereon prepared by the methods of the present invention.

FIGS. 3A-3D, 4A-4D and 5A-5F provide schematic cross-sectional representations of methods of the present invention.

FIGS. 6-9 provide images of features prepared on composite substrates using the molecular resists of the present invention, as described in Examples 19-22, respectively.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above”, “below”, “up”, “down”, “top”, “bottom,” etc.) made herein are for purposes of description and illustration only, and should be interpreted as non-limiting upon the stamps, substrates, coatings, compositions, methods, and products of any method of the present invention, which can be spatially arranged in any orientation or manner.

### Substrates and Features

The molecular resist patterns and features prepared by the methods of the present invention are formed on a substrate. Substrates suitable for patterning by the methods of the present invention are not particularly limited by size, composition, or geometry, and include any substrate capable of being contacted with a stamp. For example, the methods of the present invention are suitable for patterning planar, non-planar, flat, curved, spherical, rigid, flexible, symmetric, and asymmetric objects and surfaces, and any combination thereof. The methods are also not limited by surface roughness or surface waviness, and are equally applicable to smooth, rough and wavy substrates, and substrates exhibiting heterogeneous surface morphology (i.e., substrates having varying degrees of smoothness, roughness, waviness and/or composition).

As used herein, a substrate is “planar” if, after accounting for random variations in the height of a substrate (e.g., surface roughness, waviness, etc.), points on the surface of the substrate lie in approximately the same plane. Planar substrates can include, but are not limited to, windows, embedded circuits, sheets, and the like. Planar substrates can include flat variants of the above having holes there through.

In some embodiments, at least a portion of a substrate is non-planar. As used herein, a substrate is “non-planar” if, after accounting for random variations in the height of a substrate (e.g., surface roughness, waviness, etc.), points on the surface of the substrate do not lie in the same plane. Non-planar substrates can include, but are not limited to, gratings, substrates having a tiered geometry, and the like.

Both planar and non-planar substrates can be exhibit varying degrees of flatness or curvature, or can be flexible (i.e., capable of mechanical deformation between flat and curved geometries). As used herein, a substrate is “curved” when the radius of curvature of a substrate is non-zero over a distance of 100 μm or greater, or 1 mm or greater, across the surface of a substrate. Flat substrates generally do not have a radius of curvature.

As used herein, a substrate is “rigid” when the plane, curvature, or geometry of the substrate cannot be easily distorted. Rigid substrates can undergo temperature-induced distortions due to thermal expansion, or can become flexible at temperatures above a glass transition, and the like.

As used herein, a substrate is “flexible” when it can be reversibly moved between flat and curved geometries. Flexible substrates include, but are not limited to, polymers (e.g., plastics), woven fibers, thin films, metal foils, composites thereof, laminates thereof, and combinations thereof. In some embodiments, a flexible substrate can be patterned using the methods of the present invention in a reel-to-reel or a roll-to-roll manner.

Substrates for use with the present invention are not particularly limited by composition. Substrates suitable for use with the present invention include materials chosen from: metals, crystalline materials (e.g., monocrystalline, polycrystalline, and partially crystalline materials), amorphous materials, conductors, semiconductors, insulators, optics, painted substrates, fibers, glasses, ceramics, zeolites, plastics, thermosetting and thermoplastic materials (e.g., optionally doped: polyacrylates, polycarbonates, polyurethanes, polystyrenes, cellulosic polymers, polyolefins, polyamides, polyimides, resins, polyesters, polyphenylenes, and the like), films, thin films, foils, plastics, polymers, wood, minerals, biomaterials, living tissue, bone, alloys thereof, composites thereof, laminates thereof, and any other combinations thereof. In some embodiments, a material is selected from a doped and/or a porous variant of any of the above materials.

In some embodiments, at least a portion of a substrate is conductive or semiconductive. As used herein, “conductive” and “semiconductive” materials include species, compounds, polymers, films, coatings, substrates, and the like capable of transporting or carrying electrical charge. Generally, the charge transport properties of a semiconductive material can be modified based upon an external stimulus such as, but not limited to, an electrical field, a magnetic field, a temperature change, a pressure change, exposure to radiation, and combinations thereof. In some embodiments, a conductive or semiconductive material has an electron or hole mobility of about 10⁻⁶ cm²/V·s or greater, about 10⁻⁵ cm²/V·s or greater, about 10⁻⁴ cm²/V·s or greater, about 10⁻³ cm²/V·s or greater, about 0.01 cm²/V·s or greater, or about 0.1 cm²/V·s or greater. Electrically conductive and semiconductive materials include, but are not limited to, metals, alloys, thin films, crystalline materials, amorphous materials, polymers, laminates, foils, plastics, and combinations thereof.

As used herein, a “dielectric” or an “insulator” refers to species, compounds, polymers, films, coatings, substrates, and the like that are resistant to the movement or transfer of electrical charge. In some embodiments, a dielectric has a dielectric constant, ρ, of about 0.9 to about 10, about 1.2 to about 8, about 1.4 to about 5, about 1.5 to about 4, about 1.7 to about 3, about 2 to about 2.7, about 2.1 to about 2.5, about 8 to about 90, about 15 to about 85, about 20 to about 80, about 25 to about 75, or about 30 to about 70. Dielectrics suitable for use with the present invention include, but are not limited to, plastics, polymers (e.g., polydimethylsiloxane, a silsesquioxane, a polyethylene, a polypropylene, and the like), metal oxides, metal carbides, metal nitrides, ceramics (e.g., silicon carbide, hydrogenated silicon carbide, silicon nitride, silicon carbonitride, silicon oxynitride, silicon oxycarbide, and combinations thereof), glasses (e.g., SiO₂, borosilicate glass, borophosphorosilicate glass, organosilicate glass, etc., and fluorinated and porous variants thereof), zeolites, minerals, biomaterials, living tissue, bone, monomeric precursors thereof, particles thereof, porous variants thereof, and combinations thereof.

Plastics suitable for use with the present invention include those materials disclosed, for example but not limitation, in Plastics Materials and Processes: A Concise Encyclopedia, Harper, C. A. and Petrie, E. M., John Wiley and Sons, Hoboken, N.J. (2003) and Plastics for Engineers: Materials, Properties, Applications, Domininghaus, H., Oxford University Press, USA (1993), which are incorporated herein by reference in their entirety.

In some embodiments, a substrate comprises a first area including a conductive or semiconductive material and a second area including a dielectric or insulating material. The substrate can be flat, curved, or tiered, and can include topographical features such as thin-film transistors, capacitors, and the like.

Exemplary substrates on which a feature can be formed by the methods of the present invention include, but are not limited to, windows; mirrors; optical elements (e.g, optical elements for use in eyeglasses, cameras, binoculars, telescopes, and the like); watch crystals; holograms; optical filters; data storage devices (e.g., compact discs, DVD discs, Blu-ray discs, CD-ROM discs, and the like); flat panel displays (e.g., liquid crystal displays, plasma displays, light-emitting diode (“LED”) displays, organic LED displays, and the like); personal music devices; touch-screen displays (such as those of computer touch screens, cellular phone touch screens, personal data assistants, and the like); solar cells; photovoltaics; LEDs; lighting; flexible electronics; flexible displays (e.g., electronic paper and electronic books); cellular phones; global positioning systems; calculators; diagnostics; sensors; resist layers; biological interfaces; antireflection coatings; graphic articles (e.g., signage); batteries; fuel cells; antennas; motor vehicles; artwork (e.g., sculptures, paintings, lithographs, and the like); jewelry; and combinations thereof.

The present invention contemplates optimizing the performance, efficiency, cost, and speed of the patterning processes by selecting molecular resists, inks, stamps and substrates that are compatible with one another. For example, in some embodiments, a molecular resist, an ink, a substrate or a stamp can be selected based upon its optical transmission properties, thermal conductivity, electrical conductivity, and combinations thereof.

In some embodiments, at least a portion of a substrate is transparent, translucent, or opaque to at least one type of radiation suitable for initiating a reaction of a reactive composition on the substrate (e.g., visible, UV, infrared and/or microwave radiation). For example, a substrate transparent to ultraviolet light can be used with a reactive composition whose reaction can be initiated by ultraviolet light, which permits the reaction of an ink on the front-surface of a substrate to be initiated by illuminating a back-surface of the substrate with ultraviolet light.

In some embodiments, the substrate is pre-treated prior to patterning. As used herein, “pre-treating the substrate” refers to chemically or physically modifying a substrate prior to disposing a molecular resist. Pre-treating can include, but is not limited to, cleaning, oxidizing, reducing, derivatizing, functionalizing, as well as exposing a substrate to: a reactive gas, an oxidizing plasma, a reducing plasma, a thermal energy, an ultraviolet radiation, and combinations thereof

Not being bound by any particular theory, pre-treating a substrate can increase an adhesive interaction between a molecular resist and a substrate. For example, derivatizing a substrate with a polar functional group (e.g., oxidizing a surface of the substrate) can promote the wetting of a substrate by a hydrophilic and/or polar molecular resist.

As used herein, a “feature” or a “feature” refers to an area of a substrate that is contiguous with, and can be distinguished from, the areas of the substrate surrounding the feature. For example, a feature can be distinguished from the areas of the substrate surrounding the feature based upon the topography of the feature, composition of the feature, or another property of the feature that differs from the areas of the substrate surrounding the feature. Features are prepared by reacting a reactive composition with an area of the substrate not covered by a molecular resist of the present invention.

Features can be defined by their physical dimensions. All features have at least one lateral dimension. As used herein, a “lateral dimension” refers to a dimension of a feature that lies in the plane of a surface. One or more lateral dimensions of a feature define, or can be used to define, the surface area of a substrate that a feature occupies.

Typical lateral dimensions of features include, but are not limited to: length, width, radius, diameter, and combinations thereof. Features formed by the methods of the present invention have lateral dimensions defined by the dimensions of a molecular resist pattern disposed on the substrate.

All features have at least one vertical dimension that can be described by a vector that lies out of the plane of a substrate. As used herein, a “vertical dimension” or “elevation” refers to the largest vertical distance between the height of the surface of a substrate and the highest or lowest point on a feature. For flat substrates, the elevation of a feature refers to its highest point of the feature relative to the plane of the substrate. In some embodiments, features prepared by the present invention have a uniform elevation across the surfaces of the features. More generally, the elevation of an additive feature refers to its highest point relative to a plane of a substrate, the elevation of a subtractive feature refers to its lowest point relative to the plane of a substrate, and a conformal feature has an elevation of zero (i.e., is at the same height as the plane of the substrate).

A feature produced by the methods of the present invention can generally be classified as: an additive feature, a conformal feature, or a subtractive feature, based upon the elevation of the feature relative to a plane of the substrate.

A feature produced by the methods of the present invention can be further classified as: a penetrating feature or a non-penetrating feature, based upon whether or not the base of a feature penetrates below the plane of a substrate on which it is formed. As used herein, a “penetration distance” refers to the distance between the lowest point of a feature and the height of the substrate adjacent to the feature. More generally, the penetration distance of a feature refers to its lowest point relative to the plane of the substrate. Thus, a feature is said to be “penetrating” when its lowest point is located below the plane of the substrate on which the feature is located, and a feature is said to be “non-penetrating” when the lowest point of the feature is located within or above the plane of the substrate on which it is located. A non-penetrating feature can be said to have a penetration distance of zero.

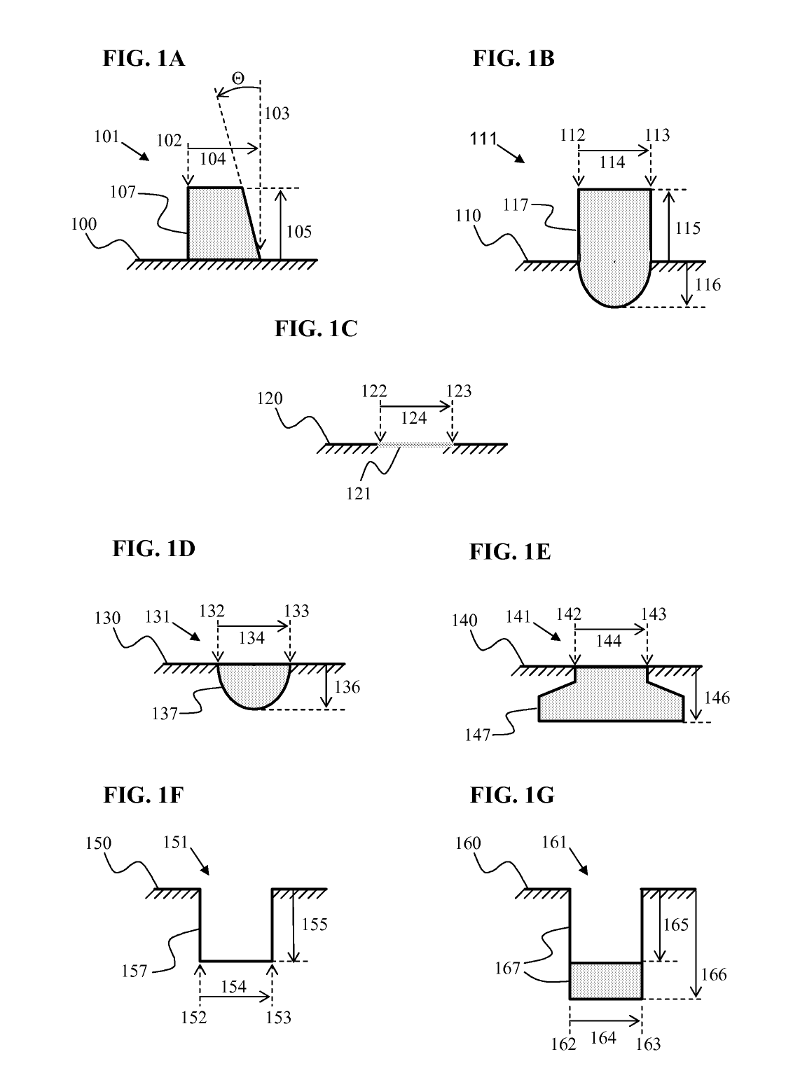

As used herein, an “additive feature” refers to a feature having an elevation that is above the plane of a substrate. Thus, the elevation of an additive feature is greater than the elevation of the surrounding substrate. FIGS. 1A and 1B provide cross-sectional schematic representations of a substrate, 100 and 110, respectively, having “additive features”, 101 and 111, respectively. Referring, to FIG. 1A, the additive “non-penetrating” feature, 101, has a lateral dimension, 104, an elevation, 105, and a penetration distance of zero. Referring to FIG. 1B, the “additive penetrating” feature, 111, has a lateral dimension, 114, an elevation, 115, and a penetration distance, 116.

As used herein, a “conformal feature” refers to a feature having an elevation that is even with a plane of the substrate on which the feature is located. Thus, a conformal feature has substantially the same topography as the surrounding substrate. As used herein, a “conformal non-penetrating” feature refers to a feature that is purely on the surface of a substrate. For example, a reactive composition that reacts with the exposed functional groups of a substrate such as, for example, by oxidizing, reducing, or functionalizing the substrate, would form a conformal non-penetrating feature. FIG. 1C shows a cross-sectional schematic representation of a substrate, 120, having a “conformal non-penetrating” feature, 121. The feature, 121, has a lateral dimension, 124, and has an elevation of zero and a penetration distance of zero. FIG. 1D shows a cross-sectional schematic representation of a substrate, 130, having a “conformal penetrating” feature, 131, The feature, 131, has a lateral dimension, 134, an elevation of zero, and penetration distance, 136. FIG. 1E shows a cross-sectional schematic representation of a substrate, 140, having a “conformal penetrating” feature, 141, The feature, 141, has a lateral dimension, 144, an elevation of zero, and penetration distance, 146.

As used herein, a “subtractive feature” refers to a feature having an elevation that is below the plane of the surface. FIG. 1F shows a cross-sectional schematic representation of a substrate, 150, having a “subtractive non-penetrating” feature, 151. The feature, 151, has a lateral dimension, 154, an elevation, 155, and penetration distance of zero. FIG. 1G shows a cross-sectional schematic representation of a substrate, 160, having a “subtractive penetrating” feature, 161. The feature, 161, has a lateral dimension, 164, an elevation, 165, and a penetration distance, 166.

In some embodiments, a feature has an “angled” sidewall. As used herein, an “angled sidewall” refers to a sidewall that is not orthogonal to a plane oriented parallel to the substrate. The sidewall angle is equal to the average angle formed between a vector orthogonal to the surface that intersects an edge of a feature and a vector intersecting the edge of the feature at the same point that is parallel to the surface of the sidewall. An orthogonal sidewall has a sidewall angle of about 0°. Referring to FIG. 1A, for example, the feature 101, having a sidewall, 107, has a sidewall angle, Θ. While the sidewall angle depicted in FIG. 1A is constant over the surface of the sidewall, 107, the sidewall angle can also vary. For example, features having curved, faceted and sloped sidewalls are within the scope of the present invention. For example, referring to FIG. 1D, the feature, 131, forms a curved sidewall, 137, in which the substrate, 130, surrounds the sidewall. In some embodiments, a feature includes a sidewall that is curved and/or sloped near the top and/or bottom of the feature. An “average sidewall angle” can be calculated by averaging an angle formed between a point on a sidewall and the substrate over the surface of the sidewall. In some embodiments, a feature formed by the methods of the present invention has a sidewall angle or an average sidewall angle of about 80° to about −50°, about 80° to about −30°, about 80° to about −10°, or about 80° to about 0°.

Features can be further differentiated based upon their composition and utility.

For example, features produced by the methods of the present invention include structural features, conductive features, semi-conductive features, insulating features, and masking features.

As used herein, a “structural feature” refers to feature having a composition similar or identical to the composition of the substrate on which the feature is located.

As used herein, a “conductive feature” refers to a feature having a composition that is electrically conductive, or electrically semi-conductive. Electrically semi-conductive features include features whose electrical conductivity can be modified based upon an external stimulus such as, but not limited to, an electrical field, a magnetic field, a temperature change, a pressure change, exposure to radiation, and combinations thereof

As used herein, a “dielectric feature” or an “insulating feature” refers to a feature having a composition that is electrically insulating.

As used herein, a “masking feature” refers to a feature that has composition that is inert to reaction with a reagent that is reactive towards an area of the substrate adjacent to and surrounding the feature. Thus, a masking feature can be used to protect an area of a substrate during subsequent process steps, such as, but not limited to, etching, deposition, implantation, and surface treatment steps. In some embodiments, a feature can be removed, modified, during or after subsequent process steps.

### Feature Size and Measurement

A feature produced by the methods of the present invention has lateral and vertical dimensions that are typically defined in units of length, such as angstroms (Å), nanometers (nm), microns (μm), millimeters (mm), centimeters (cm), etc.

When an area of the surface of a substrate surrounding a feature thereon is planar, a lateral dimension of the feature can be determined by the magnitude of a vector between two points located on opposite sides of the feature, wherein the two points are in the plane of the substrate and wherein the vector is parallel to the plane of the substrate. In some embodiments, two points used to determine a lateral dimension of a symmetric feature also lie on a mirror plane of the symmetric feature. In some embodiments, a lateral dimension of an asymmetric feature can be determined by aligning a vector orthogonally to at least one edge of the feature.

For example, in FIGS. 1A-1G points lying in the plane of the substrate and on opposite sides of the features, 101, 111, 121, 131, 141, 151 and 161, are shown by dashed arrows, 102 and 103; 112 and 113; 122 and 123; 132 and 133; 142 and 143; 152 and 153, and 162 and 163, respectively. The lateral dimension of these features is shown by the magnitude of the vectors 104, 114, 124, 134, 144, 154 and 164, respectively.

A vertical dimension of a feature is the magnitude of a vector orthogonal to the substrate between a point in the plane of the substrate and a point at the top-most height of the feature. For example, in FIGS. 1A-1G the vertical dimensions of the features are shown by the magnitude of the vectors 105, 115, 125, 135, 145, 155 and 165 respectively. As used herein, a “sidewall” refers to any surface of a feature that is not substantially planar to a plane oriented parallel to the substrate, or concentric with the curvature of a non-planar substrate. For example, in FIGS. 1A, 1B and 1D-1G features 101, 111, 131, 141, 151 and 161 are shown having sidewalls 107, 117, 137, 147, 157 and 167, respectively. In those embodiments in which the sidewall of a feature is orthogonal to a plane oriented parallel to the substrate, the height of the sidewall is equal to the vertical dimension of the feature.

A surface of a substrate or the substrate itself are “curved” when the radius of curvature of a substrate surface is non-zero over a distance on the surface of the substrate of 100 μm or greater, or over a distance on the surface of the substrate of 1 mm or greater. For curved substrates, a lateral dimension of a feature is defined as the magnitude of a segment of the circumference of a circle connecting two points on opposite sides of the feature, wherein the circle has a radius equal to the radius of curvature of the substrate. A lateral dimension of a substrate having a curved surface having multiple or undulating curvature, or waviness, can be determined by summing the magnitude of segments from multiple circles.

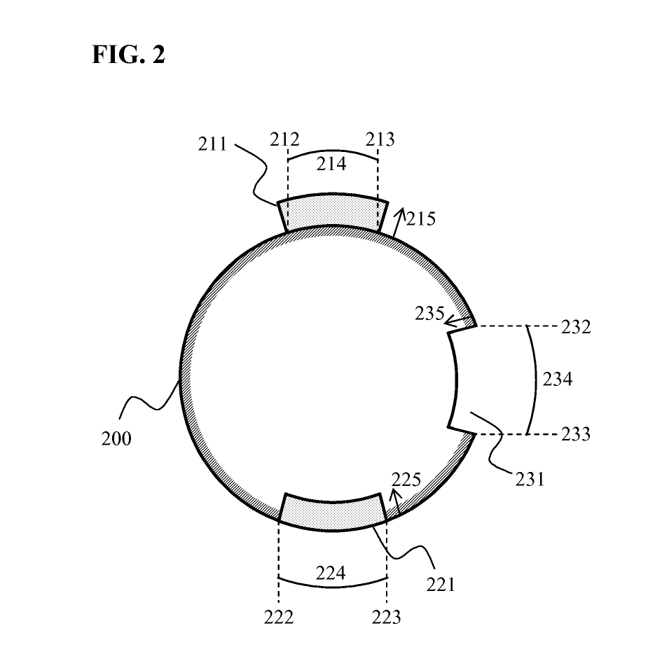

FIG. 2 displays a cross-sectional schematic of a substrate having a curved surface, 200, having an additive non-penetrating feature, 211, a conformal penetrating feature, 221, and a subtractive non-penetrating feature, 231. A lateral dimension of the additive non-penetrating feature, 211, is equivalent to the length of the line segment, 214, which can connect points 212 and 213, and the elevation of the feature, 211, is equivalent to the magnitude of the vector, 215. A lateral dimension of the conformal penetrating feature, 221, is equivalent to the length of the line segment, 224, which connect points 222 and 223. The elevation of the feature, 221, is zero, and the penetration distance of the feature, 221, is equivalent to the magnitude of the vector, 225 A lateral dimension of the subtractive non-penetrating feature, 231, is equivalent to the length of the line segment, 234, which can connect points 232 and 233, and the elevation of the feature, 231, is equivalent to the magnitude of the vector, 235. The elevation of the feature, 231, is negative in amplitude.

In some embodiments, a feature produced by the methods of the present invention has at least one lateral dimension of about 40 nm to about 500 μm. In some embodiments, a feature produced by the methods of the present invention has at least one lateral dimension having a minimum size of about 40 nm, about 50 nm, about 60 nm, about 70 nm, about 80 nm, about 100 nm, about 150 nm, about 200 nm, about 250 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 10 μm, about 15 μm, or about 20 μm. In some embodiments, a feature produced by the methods of the present invention has at least one lateral dimension having a maximum size of about 500 μm, about 400 μm, about 300 μm, about 200 μm, about 100 μm, about 50 μm, about 40 μm, about 35 μm, about 30 μm, about 25 μm, about 20 μm, about 15 μm, about 10 μm, about 5 μm, about 2 μm, or about 1 μm.

In some embodiments, a feature produced by the methods of the present invention has an elevation or penetration distance of about 3 Å to about 100 μm. In some embodiments, a feature produced by the methods of the present invention has a minimum elevation or penetration distance of about 3 Å, about 5 Å, about 8 Å, about 1 nm, about 2 nm, about 5 nm, about 10 nm, about 15 nm, about 20 nm, about 30 nm, about 50 nm, about 100 nm, about 500 nm, about 1 μm, about 2 μm, about 5 μm, about 10 μm, or about 20 μm above or below the surface of a substrate. In some embodiments, a feature produced by the methods of the present invention has a maximum elevation or penetration distance of about 100 μm, about 90 μm, about 80 μm, about 70 μm, about 60 μm, about 50 μm, about 40 μm, about 30 μm, about 20 μm, about 10 μm, or about 5 μm above or below the surface of a substrate.

In some embodiments, a feature produced by the methods of the present invention has an aspect ratio (i.e., a ratio of either one or both of the elevation and/or penetration distance to a lateral dimension) of about 1,000:1 to about 1:100,000, about 100:1 to about 1:100, about 80:1 to about 1:80, about 50:1 to about 1:50, about 20:1 to about 1:20, about 15:1 to about 1:15, about 10:1 to about 1:10, about 8:1 to about 1:8, about 5:1 to about 1:5, about 2:1 to about 1:2, or about 1:1.

While the features illustrated schematically in FIGS. 1A-1G show that the features 101, 111, 121, 131, 141, 151 and 161 have compositions that differ from the substrate regions immediately surrounding the features, the present invention encompasses features having both the same and different chemical compositions compared to the substrate. For example, a feature can be formed by a combination of an additive process (e.g., deposition), and a reactive process (e.g., reaction between a reactive composition and the substrate), and combinations thereof.

A lateral and/or vertical dimension of an additive or subtractive feature can be determined using an analytical method that can measure surface topography such as, for example, scanning mode atomic force microscopy (AFM) or profilometry. Conformal features cannot typically be detected by profilometry methods. However, if the surface of a conformal feature is terminated with a functional group whose polarity differs from that of the surrounding surface areas, a lateral dimension of the feature can be determined using, for example, tapping mode AFM, functionalized AFM, scanning probe microscopy, and the like.

Features can also be identified based upon a property such as, but not limited to, conductivity, resistivity, density, permeability, porosity, hardness, electric charge, magnetism, and combinations thereof using, for example, scanning probe microscopy.

In some embodiments, a feature can be differentiated from the surrounding surface area using, for example, scanning electron microscopy or transmission electron microscopy.

In some embodiments, a feature has a different composition or morphology compared to the surrounding surface area. Thus, surface analytical methods can be employed to determine both the composition of the feature, as well as the lateral dimension of the feature. Analytical methods suitable for determining the composition and lateral and vertical dimensions of a feature include, but are not limited to, Auger electron spectroscopy, energy dispersive x-ray spectroscopy, micro-Fourier transform infrared spectroscopy, particle induced x-ray emission, Raman spectroscopy, x-ray diffraction, x-ray fluorescence, laser ablation inductively coupled plasma mass spectrometry, Rutherford backscattering spectrometry/Hydrogen forward scattering, secondary ion mass spectrometry, time-of-flight secondary ion mass spectrometry, x-ray photoelectron spectroscopy, and combinations thereof.

### Molecular Resists

While the patterning of methods of the present invention are generally suitable for use with any molecular resist composition comprising an organic amine, in some embodiments the present invention is further directed to specific molecular resist compositions, as further described herein. As used herein, a “molecular resist” refers to a homogeneous composition comprising an organic amine suitable for forming a thin film on a substrate. A “homogeneous composition” refers to the molecular resist being substantially uniform in terms of component concentration. As used herein, a “molecular resist” can refer to a solution, a suspension, a mixture, a gel, a cream, a glue, an adhesive, and any other fluid, liquid, and/or viscous liquid composition.

The molecular resist compositions of the present invention comprise an organic amine. As used herein, an “organic amine” refers to a compound including at least one carbon atom and having at least one amine group attached to a carbon atom. The bond between the amine group and the carbon atom can be a single bond, a double bond, a triple bond, or an aromatic bond. In some embodiments, the organic amine includes at least one amine group, two or more amine groups, or three or more amine groups. In some embodiments, the organic amine includes at least one double bond, one or more groups of conjugated double bonds, at least one triple bond, or is aromatic.

In some embodiments, the amine group is a terminal group (e.g., —NH₂, —N⁺≡N, —N═N⁺N⁻, and the like).

In some embodiments, the amine group is a member of a ring. For example, organic amines comprising an amine group as a member of a ring include, but are not limited to, pyrrole, pyrollidine, pyrazole, piperidine, imidazole, indole, indazole, purine, quinolizine, quinoline, phthalazine, naphthyridine, quinoxaline, quinazoline, cinnoline, pteridine, carbazole, carboline, phenanthridine, acridine, perimidine, phenanthroline, phenazine, isothiazole, phenothiazine, isoxazole, furazan, phenoxazine, and the like, and combinations thereof.

In some embodiments, the amine group is bonded to a metal. For example, organic amines comprising an amine group bonded to a metal include, but are not limited to, a metalloporphyrin, a metallophthalocyanine, metalloporphyrazin, a metallotetrabenzoporphyrin, and the like. The present invention also includes the use of organic amines in which a metal is present, but there is no bond between the metal and a nitrogen atom, for example, ethylenediaminetetraacetic acid, and the like.

In some embodiments, an organic amine refers to a compound comprising a primary amine group (i.e., a —NH₂ group), a secondary amine group (i.e., a —NHR group, wherein R is a straight-chain, branched, or cyclic C₁-C₁₄ alkyl or C₆-C₁₄ aryl), a tertiary amine group (i.e., a —N(R)(R′) group, wherein R and R′ are independently straight-chain, branched, or cyclic C₁-C₁₄ alkyl or C₆-C₁₄ aryl), a quaternary ammonium group (i.e., a —N⁺(R)(R′)(R″) group, wherein R, R′ and R″ are independently straight-chain, branched, or cyclic C₁-C₁₄ alkyl or C₆-C₁₄ aryl), compounds comprising combinations thereof, and mixtures of compounds comprising these functional groups. In some embodiments, the amine group is present as an addition salt (e.g., a quaternary ammonium group, an acid addition salt, and the like).

In some embodiments, the molecular resist composition comprises a dye molecule. In some embodiments, the molecular resist composition comprises a compound having a molar absorptivity of about 5,000 M⁻¹ cm⁻¹ or greater for at least one wavelength in the range of about 300 nm to about 900 nm. In some embodiments, the molecular resist composition comprises a compound having a molar absorptivity of about 10,000 M⁻¹ cm⁻¹ or greater, about 15,000 M⁻¹cm⁻¹ or greater, about 20,000 M⁻¹ cm⁻¹ or greater, about 25,000 M⁻¹ cm⁻¹ or greater, about 50,000 M⁻¹ cm⁻¹ or greater, about 75,000 M⁻¹ cm⁻¹ or greater, about 100,000 M⁻¹ cm⁻¹ or greater, or about 125,000 M⁻¹ cm⁻¹ or greater for at least one wavelength in the range of about 300 nm to about 900 nm, about 400 nm to about 900 nm, about 400 nm to about 800 nm, or about 400 nm to about 700 nm.

In some embodiments, a molecular resist composition comprises a charged compound (e.g., a compound having a net positive charge, a compound having a net negative charge, or a salt thereof). In some embodiments, a charged compound is a quaternary ammonium compound.

In some embodiments, the molecular resist composition is free from any component having a molecular weight of about 2,000 Da or greater. In some embodiments, the molecular resist composition is free from any component having a molecular weight of about 1,800 Da or greater, about 1,600 Da or greater, about 1,500 Da or greater, about 1,400 Da or greater, or about 1,300 Da or greater. In some embodiments, the molecular resist compositions are substantially free from a polymer.

As used herein, a “polymer” refers to a linear, branched, or optionally cross-linked species, compounds, moiety, and the like comprising about 10 or more covalently linked monomers or building blocks. Polymers also include copolymers and the like comprising mixtures of differing monomers. In particular, in some embodiments the molecular resist compositions of the present invention are substantially free from polymers such as poly(acrylates), poly(alkylacrylates), poly(acrylonitriles), polymers bearing photo-acid generating functional groups, fluorinated variants thereof, and the like that are commonly present in polymeric etch resist compositions suitable for use with, for example, photolithographic patterning processes.

While the molecular resist compositions of the present invention are typically substantially free from a polymer, it is also within the scope of the present invention for the molecular resist composition to comprise an optional surface capping agent and/or a lubricant, and the like. Capping agents can be utilized in ink compositions to prevent, for example, evaporation of a solvent or other species from an ink.

While the molecular resist compositions of the present invention are typically substantially free from a polymer, it is also within the scope of the present invention for the molecular resist composition to comprise a dimers, trimers, tetramers and the like, of an organic amine. Such multimers of an organic amine can be formed in situ during mixing, storage, applying, and the like. A multimer of an organic amine would not be expected to adversely affect the etch resistance of a molecular resist of the present invention compared to a pattern comprising solely monomeric organic amines. Multimeric species, if present, are typically present in a sufficiently low enough concentration to not be the primary component of the composition. For example, in some embodiments a multimeric species of an organic is present in a concentration of less than about 50%, about 45% or less, about 10% or less, about 5% or less, about 3% or less, about 2% or less, about 1% or less, about 0.5% or less, about 0.1% or less, about 0.05% or less, or about 0.01% or less by weight of the molecular resist composition. Alternatively, a multimeric species of an organic amine described herein can be a primary component of a molecular resist of the present invention, and be present in a concentration of about 50% or more, about 60% or more, about 70% or more, about 80% or more, or about 90% or more by weight of the molecular resist.

It is also within the scope of the present invention for the molecular resist composition to undergo partial polymerization and/or cross-linking after a molecular resist pattern has been formed on a substrate. Such embodiments differ considerably from methods in which a polymeric etch resist is either cross-linked or de-polymerized using light because the polymerization or depolymerization of the polymer is utilized as the patterning mechanism. On the other hand, patterning of the molecular resist compositions of the present invention can be achieved without the use of light or chemical reactions, for example via self-alignment or self-assembly processes wherein polymerization, if present, typically can occur after a pattern has been formed.

In some embodiments, the molecular resist composition comprises an organic amine having the structure of Formula I:

A-(B)ₘ-C I

or a salt thereof, wherein:
A and C are independently chosen from: optionally substituted cycloalkyl, optionally substituted aryl, and optionally substituted heterocyclyl, or A and C are optionally joined to form a macrocyclic ring;
A and C each include at least one double bond;
B is an optionally substituted bridging group or a chemical bond;
m is an integer from 1 to 3, and
the organic amine of Formula I includes at least one amine group attached to at least one of A, B, and C, or an optional substituent thereof.

In some embodiments, the molecular resist composition comprises an organic amine having the structure of Formula II:

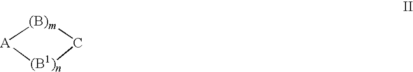

or a salt thereof; wherein:
A and C are as defined above;
B and B¹ are independently optionally substituted bridging groups;
m and n are independently integers from 1 to 3; and
the organic amine of Formula II includes at least one amine group attached to at least one of A, C, B, and B¹, or an optional substituent thereof

In some embodiments, the molecular resist composition comprises an organic amine having the structure of Formula III:

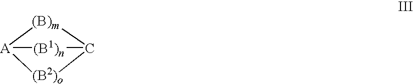

or a salt thereof; wherein:
A and C are as defined above;
B, B and B² are independently optionally substituted bridging groups;
m, n and o are independently integers from 1 to 3; and
the organic amine of Formula III includes at least one amine group attached to at least one of A, C, B, B¹ and B², or an optional substituent thereof

Suitable optionally substituted bridging groups, B, of the present invention also include a metal chosen from: a transition metal, aluminum, silicon, phosphorous, gallium, germanium, indium, tin, antimony, lead, bismuth, and combinations thereof. For example, in some embodiments, the molecular resist includes an organic amine having the structure of Formula IV:

A-M(L)ₙ-C IV
or a salt thereof, wherein:
A and C are as defined above;
M is a divalent, trivalent, tetravalent, pentavalent, or hexavalent metal;
L is an optionally substituted monodentate, bidentate, tridentate or tetradentate ligand,
n is an integer from 0 to 4; and
the organic amine of Formula IV includes at least one amine group attached to at least one of A, C and L, or an optional substituent thereof.

In some embodiments, the molecular resist composition comprises an organic amine having the structure of Formula V:

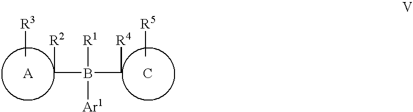

or a salt thereof, wherein:
ring systems A and C are independently a 4- to 14-membered ring system chosen from: optionally substituted cycloalkyl, optionally substituted aryl, and optionally substituted heterocyclyl;
B is an optionally substituted bridging group;
R¹ is as defined herein; or
R¹ and R³ or R¹ and R⁵ are hydrogen or are optionally joined to form a 4- to 14-membered ring system chosen from: optionally substituted cycloalkyl, optionally substituted aryl, and optionally substituted heterocyclyl;
R¹ and R² or R¹ and R⁴ are independently hydrogen or are optionally joined to form a double bond, or R¹ is optionally absent;
R² is optionally joined with a member of ring A to form a double bond or a bridging group, R⁴ is optionally joined with a member of ring C to form a double bond or a bridging group, or R² and R⁴ are optionally absent;
Ar¹ is chosen from phenyl, naphthyl or aromatic heterocyclyl, any of which is optionally substituted; and
the organic amine of Formula V includes at least one amine group attached to at least one of Ar¹, R¹, R², R³, R⁴, R⁵, ring system A, ring system C, and B, or an optional substituent thereof

In some embodiments, B is a chemical bond chosen from a single bond, a double bond, or a triple bond.

In some embodiments, the optionally substituted bridging group (i.e., any of B, B¹ or B² herein) is a group chosen from: —CR¹⁰R¹¹—, —CR¹⁰═, ═C═, —C≡, —NR¹⁰—, —N═, —O—, —S—, —PR¹⁰—, —CR¹⁰R¹¹—CR¹²R¹³—, —CR¹⁰═CR¹¹—, ═CR¹⁰—CR¹¹R¹²—, —CR¹⁰R¹¹—CR¹²═, —C≡C—, ≡C—CR¹⁰R¹¹—, —CR¹⁰R¹¹—C≡, —NR¹⁰—CR¹¹R¹²—, —CR¹⁰R¹¹—NR¹²—, —CR¹⁰═N—, ═CR¹⁰—NR¹¹—, —CR¹⁰R¹¹—N═, —CR¹⁰═P—, ═CR¹⁰R¹¹—, —CR¹⁰R¹¹—P═, —NR¹⁰—NR¹¹—, ═N—NR¹⁰—, —NR¹⁰—N═, —N═N—, —O—CR¹⁰R¹¹—, —CR¹⁰R¹¹—O—, —O—CR¹⁰═, ═CR¹⁰—O—, ≡C—O—, —O—C≡, —O—O—, —S—CR¹⁰R¹¹—, —CR¹⁰R¹¹—S—, —S—CR¹⁰═, ═CR¹⁰—S—, ≡C—S—, —S—C≡, —S—S—, and combinations thereof, wherein R¹ (in Formula V), R¹⁰, R¹¹, R¹² and R¹³ are independently chosen from H, optionally substituted alkyl, optionally substituted cycloalkyl, optionally substituted alkenyl, optionally substituted aryl, optionally substituted heteroalkyl, and optionally substituted heterocyclyl, or in compounds of Formula II and III, any of R¹⁰, R¹¹, R¹² and R¹³ are optionally joined to form a chemical bond linking B and B¹, B and B², B¹ and B², and combinations thereof.

As used herein, “alkyl” or “alk” alone or as part of another group include both straight- and branched-chain hydrocarbons containing 1 to 12 carbons, preferably 1 to 10 carbons, and more preferably 1 to 8 carbons, such as methyl, ethyl, propyl, iso-propyl, butyl, tert-butyl, iso-butyl, pentyl, hexyl, iso-hexyl, heptyl, 4,4-dimethylpentyl, octyl, 2,2,4-trimethylpentyl, and the like. As used herein, “lower alkyl” refers to such groups containing 1-4 carbon atoms. Unless otherwise indicated, alkyl groups having single bonds for attachment to other groups at two different carbon atoms are referred to as “alkylene” groups, and can optionally be substituted. In some embodiments, the bridging group is an optionally substituted C₃-C₈ alkylene (i.e., methylene (—CH₂—)ₓ, wherein x is 3 to 8), an optionally branched isomer thereof, a heteroatomic variant thereof, and combinations thereof.

As used herein, “alkenyl” alone or as part of another group refers to straight- and branched-chain radicals and/or bi-radicals of 2 to 12 carbons, preferably 2 to 10 carbons, and more preferably 2 to 8 carbons such as, but not limited to, vinyl, 2-propenyl, 3-butenyl, 2-butenyl, 4-pentenyl, 3-pentenyl, 2-hexenyl, 3-hexenyl, 2-heptenyl, 3-heptenyl, 4-heptenyl, 3-octenyl, 3-nonenyl, 4-decenyl, 3-undecenyl, 4-dodecenyl, 4,8,12-tetradecatrienyl, and the like. Unless otherwise indicated, alkenyl groups can be optionally substituted at any place in any combination that provides a stable compound.

As used herein, “alkynyl” alone or as part of another group refers to straight or branched chain radicals of 2 to 12 carbons, preferably 2 to 10 carbons and more preferably 2 to 8 carbons such as 2-propynyl, 3-butynyl, 2-butynyl, 4-pentynyl, 3-pentynyl, 2-hexynyl, 3-hexynyl, 2-heptynyl, 3-heptynyl, 4-heptynyl, 3-octynyl, 3-nonynyl, 4-decynyl, 3-undecynyl, 4-dodecynyl and the like. As used herein, “lower alkynyl” refers to such groups containing 2-4 carbon atoms. Unless otherwise indicated, alkynyl groups can be substituted with 1 or more “optional substituents” that can be the same or different at each occurrence. These substituents can occur at any place in any combination that provides a stable compound.

In some embodiments, alkyl, alkenyl and alkynyl groups can themselves function as optional substituents, in which the alkyl, alkenyl or alkynyl group can be attached to a compound of the present invention by a single bond, a double bond, or a triple bond at one attachment point, at two different attachment points, and combinations thereof.

As used herein, “cycloalkyl” alone or as part of another group refers to saturated and partially unsaturated (i.e., containing one or more carbon-carbon double bonds) cyclic hydrocarbon groups containing 1 to 3 rings, containing a total of 3 to 16 carbons forming the ring(s), and preferably containing 3 to 12 carbons forming the ring(s). Polycyclic systems may contain fused or bridged rings or both. In addition, a cycloalkyl group can be fused to 1 or 2 aryl rings. Examples of cycloalkyl groups include, but are not limited to, cyclopropyl, cyclobutyl, cyclopentyl, cyclohexyl, cycloheptyl, cyclooctyl, cyclodecyl cyclododecyl, cyclohexenyl, adamantyl, decahydronaphthyl,

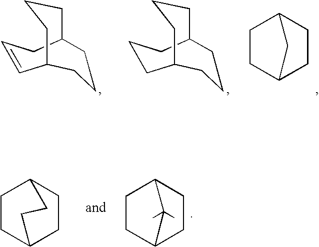

Unless otherwise indicated, cycloalkyl groups can be optionally substituted with 1 or more substituents as described herein that can be the same or different at each occurrence. These substituents can occur at any place in any combination that provides a stable compound. In some embodiments, the bridging group is an optionally substituted bivalent cyclic group chosen from: cyclopropylene, cyclobutylene, cyclopentylene, cyclohexylene, cycloheptylene, and optionally partially unsaturated forms thereof.

As used herein, “aryl” alone or as part of another group refers to monocyclic, bicyclic, and tricyclic aromatic groups containing 6 to 14 carbons in the ring portion (such as, but not limited to, phenyl, naphthyl, anthryl, and phenanthryl) and can optionally include one to three additional rings fused to a carbocyclic ring. Unless otherwise indicated, aryl groups can be optionally substituted with 1 or more optional substituents that can be the same or different at each occurrence. These substituents can occur at any place in any combination that provides a stable compound.

In some embodiments, an optionally substituted bridging group of the present invention is an optionally substituted bivalent aryl group chosen from: phenylene, pentalylene, indenylene, indacylene, phenalylene, benzocyclooctylene, fluorenylene, azulylene, heptalylene, naphthylene, anthrylene, acenaphthenylene, biphenylene, and phenanthrylene.

As used herein, “hetercyclo” and “heterocyclyl” alone or as part of another group refer to a monocyclic or multicyclic ring systems wherein one or more of the ring atoms is an element other than carbon. Preferred heterocyclyl systems have 1 to 4 of the atoms independently selected from N, O, S, P, and combinations thereof. The ring system can be unsaturated, partially saturated, fully saturated or aromatic. Heterocyclo groups containing more than one ring can be fused or bridged. Heteroatoms can be optionally oxidized. Attachment can be through any available atom in the ring system. Unless otherwise indicated, heterocyclo groups can be substituted with 1 or more “optional substituents” that can be the same or different at each occurrence. These substituents may occur at any place in any combination that provides a stable compound.

In some embodiments, an optionally substituted bridging group of the present invention is a bivalent heterocyclic group chosen from: pyrrolidinediyl, thiophenediyl, benzothiophenediyl, thianthrenediyl, piperidinediyl, piperazinediyl, morpholinediyl, tetrahydrofurandiyl, furandiyl, benzofurandiyl, iso-benzofurandiyl, pyrandiyl, chromenediyl, xanthenediyl, phenoxathiindiyl, pyrrolediyl, imidazolediyl, pyrazolediyl, pyridinediyl, pyrazinediyl, pyrimidinediyl, pyridazinediyl, indolizinediyl, indolediyl, iso-indolediyl, purinediyl, quinolinediyl, iso-quinolinediyl, phthalazinediyl, naphthyridinediyl, quinoxalinediyl, quinazolinediyl, cinnolinediyl, pteridinediyl, carbazolediyl, carbolinediyl, phenanthridinediyl, acridinediyl, perimidinediyl, phenanthrolinediyl, phenazinediyl, phenarsazinediyl, iso-thiazolediyl, phenothiazinediyl, iso-xazolediyl, furazandiyl, and phenoxazinediyl.

In some embodiments, the bridging group is a bivalent group chosen from: optionally substituted 3- to 8-membered cycloalkylene, optionally substituted 4- to 8-membered cycloalkenylene, optionally substituted 6- to 14-membered arylene, optionally substituted 3- to 8-membered saturated heterocyclylene, optionally substituted 4- to 8-membered unsaturated heterocyclylene, and optionally substituted 5- to 14-membered aromatic heterocyclylene.

Unless specified otherwise, a bridging group, ring, or aryl group of Formulas I-VII can be substituted with 1 or more “optional substituents” that can be the same or different at each occurrence. These substituents can occur at any place and in any combination that provides a stable compound. “Optional substituents” are chosen from:

halogen (i.e., —F, —Cl, —Br or —I);

nitro (i.e., —NO₂);

cyano (i.e., —C≡N);

iso-cyano (i.e., —N⁺≡C⁻);

hydroxy (i.e., —OH);

thio (i.e., —SH);

—CHO;

alkyl that can be substituted with one or more occurrences of R²³;

alkenyl that can be substituted with one or more occurrences of R²³;

alkynyl that can be substituted with one or more occurrences of R²³;

cycloalkyl that can be substituted with one or more occurrences of R²³;

aryl that can be substituted with one or more occurrences of R²³;

heterocyclo that can be substituted with one or more occurrences of R²³;

—OR²² (with the proviso that R²² is not H);

—SR²² (with the proviso that R²² is not H);

—S(═O)₂R²²;

—COOR²²;

—C(═O)R²² (with the proviso that R²² is not H);

—C(═O)NR²⁴R²⁵;

—S(═O)₂NR²⁴R²⁵;

—S(═O)₂N(H)C(═O)R¹²;

—S(═O)₂N(H)CO²R²² (with the proviso that R²² is not H);

—NR²⁴R²⁵;

—N(R²⁴)S(═O)₂R²⁵;

—N(R²⁴)C(O)ₓR²⁵ (wherein x is 1 or 2);

—N(R²⁴)C(═O)NR²⁵R²⁶;

—N(R²⁴)S(═O)₂NR²⁵R²⁶;

—OC(═O)R²²;

—OC(═O)OR²²;

—OC(═O)NR²⁵R²⁶;

—C(═O)N(H)S(═O)₂NR²⁵R²⁶;

—C(═O)N(H)S(═O)₂R²⁵;

oxo (i.e., ═O);

thioxo (i.e., ═S);

imino (i.e., ═NR²⁷);

—N(R²⁷)C(═NR²⁸)R²⁹;

—N(R²⁷)C(═NR²⁸)NR²⁹R³⁰;

—C(═NR²⁷)NR²⁸R²⁹;

—OC(═NR²⁷)NR²⁸R²⁹;

—OC(═NR²⁷)R²⁸;

—C(═NR²⁷)R²⁸; and

—C(═NR²⁷)OR²².

As used herein, “R²²” is a group chosen from C₁-C₄ alkyl, C₂-C₄ alkenyl, C₂-C₄ alkynyl, C₃-C₆ cycloalkyl, C₆-C₁₀ aryl, or C₁-C₆ heterocyclo each of which may be substituted with 1 to 3 independent occurrences of R²³.

As used herein, “R²³”, is a group chosen from: halogen; nitro; cyano; iso-cyano, —OR³¹; hydroxy; lower alkoxy; trifluoromethyl (—CF₃); cyano, isocyano, carbomethoxy; —C(═O)NH₂; —CHO; —SR³¹; —C(═O)OR³¹; —C(═O)R³¹; —C(═O)NR³²R³³; —S(=O)₂NR³²R³³; —NR³²R³³; —N(R³²)SO₂R³³; —N(R³²)C(O)ₓR³³ (wherein x is 1 or 2); —N(R³²)C(═O)NR³³R³⁴; —N(R³²)SO₂NR³³R³⁴; —OC(═O)R³¹; —OC(═O)OR³¹; —S(═O)₂R³¹; —S(═O)₂N(H)C(═O)R³¹; —SO₂N(H)C(═O)OR³¹ (wherein R³¹ is not H); —C(═O)N(H)SO₂NR³²R³³; —C(═O)N(H)SO₂R³¹; —OC(═O)NR³²R³³; —NR³⁵—C(═NR³⁶)R³⁷; —NR³⁵—C(═NR³⁶)OR³¹; —NR³⁵—C(═NR³⁶)NR³⁷R³⁸; —C(═NR³⁵)NR³⁶R³⁷; —OC(═NR³⁵)R³⁶; —OC(═NR³⁵)NR³⁶R³⁷; and —C(═NR³⁵)OR³¹.

As used herein, “R²⁴”, “R²⁵” and “R²⁶” are groups independently chosen from: C₁-C₄ alkyl, C₂-C₄ alkenyl, C₂-C₄ alkynyl, C₃-C₆ cycloalkyl, C₆-C₁₀ aryl, or C₄-C₆ heterocyclo each of which may be substituted with 1 to 3 independent occurrences of R²³; or R²⁴ and R²⁵, or R²⁴ and R²⁶, or R²⁵ and R²⁶ are joined to form a 5- to 8-membered heterocyclo ring which is defined as for heterocyclo wherein the substituents may be one or more occurrences of R²³.

As used herein, “R²⁷”, “R²⁸”, “R²⁹”, and “R³⁰” are groups independently chosen from —H, halogen, nitro, cyano, iso-cyano, hydroxy, —O(C₁-C₆ alkyl), —C(O)R²², —C(O)NR²⁴R²⁵, —CO²R²² (with the proviso that R²² is not H), —S(═O)₂R²², —S(═O)₂NR²⁴R²⁵, C₁-C₄ alkyl, C₂-C₈ alkenyl, C₂-C₈ alkynyl, C₃-C₈ cycloalkyl, C₆-C₁₀ aryl, or C₁-C₉ heterocyclo or R²⁷ and R²⁸ or R²⁷ and R²⁹ or R²⁷ and R³⁰ or R²⁸ and R²⁹ or R²⁸ and R³⁰ or R²⁹ and R³⁰ may be joined by an alkylene or alkenylene chain to form a 5-8 membered ring that may be optionally substituted with one or more occurrences of R²³.

As used herein, “R³¹” is a group chosen from unsubstituted lower alkyl, alkenyl, unsubstituted alkynyl, unsubstituted cycloalkyl, unsubstituted aryl, and unsubstituted heterocyclo.

As used herein, “R³²”, “R³³” and “R³⁴” are groups independently chosen from unsubstituted lower alkyl, unsubstituted lower alkenyl, unsubstituted lower alkynyl, unsubstituted cycloalkyl, unsubstituted aryl, unsubstituted heterocyclo, or R³² and R³³, or R³² and R³⁴, or R³³ and R³⁴ are joined by an unsubstituted alkylene or unsubstituted alkenylene chain to form a 5- to 8-membered unsubstituted heterocyclo ring.

As used herein, “R³⁵”, “R³⁶”, “R³⁷”, and “R³⁸” are groups chosen from nitro, cyano, iso-cyano, unsubstituted alkyl, unsubstituted alkenyl, unsubstituted alkynyl, unsubstituted cycloalkyl, unsubstituted aryl, unsubstituted heterocyclo, or R³⁵ and R³⁶, or R³⁵ and R³⁷, or R³⁵ and R³⁸, or R³⁶ and R³⁷, or R³⁶ and R³⁸, or R³⁷ and R³⁸ are joined by an unsubstituted alkylene chain or unsubstituted alkenylene chain to form a 5- to 8-membered unsubstituted heterocyclo ring.

In some embodiments, a bridging group can be joined to one or more optional substituents to form a macrocyclic ring. As used herein, a “macrocycle” refers to rings comprising 12 or more members. Exemplary macrocyclic ring-containing species suitable for use with the present invention include, but art not limited to: amine-substituted porphyrins, amine-substituted

In some embodiments, the molecular resist composition comprises an organic amine having the structure of Formula VI:

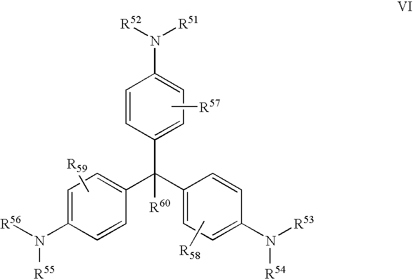

or a salt thereof; wherein: R⁵¹, R⁵², R⁵³, R⁵⁴, R⁵⁵ and R⁵⁶ are independently hydrogen or C₁-C₄ alkyl; R⁵⁷, R⁵⁸ and R⁵⁹ are independently hydrogen or methyl; and R⁶⁰ is hydrogen or C₁-C₆ alkyl.

In some embodiments, the molecular resist composition comprises an organic amine having the structure of Formula VII:

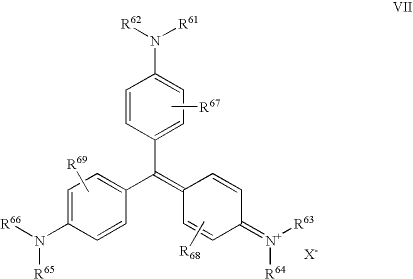

or a salt thereof; wherein: R⁶¹, R⁶², R⁶³, R⁶⁴, R⁶⁵ and R⁶⁶ are independently hydrogen or C₁-C₄ alkyl; R⁶⁷, R⁶⁸ and R⁶⁹ are independently hydrogen or methyl; and X⁻ is a monovalent anion.

All stereoisomers of the organic amines are contemplated, either in admixture or in pure or substantially pure form. The organic amines can have asymmetric centers at any of the carbon atoms including any one or the R substituents. Consequently, the organic amines of Formulas I, II, III, IV, V, VI and VII can exist in enantiomeric or diastereomeric forms or in mixtures thereof.

The organic amines can also have asymmetric centers at certain of the nitrogen or sulfur atoms. Consequently, these isomers or mixtures thereof are part of the present invention.

The present invention is considered to encompass the use of stereoisomers as well as optical isomers, e.g., mixtures of enantiomers as well as individual enantiomers and diastereomers, which arise as a consequence of structural asymmetry in selected organic amines of the present series. It is further understood that the present invention encompasses the use of tautomers of an organic amine of Formulas I, II, III, IV, V, VI and VII. Tautomers are well-known in the art and include keto-enol tautomers.

The organic amines for use with the present invention can also display other instances of chirality, such as atropoisomerism. Thus, these isomers or mixtures thereof are part of the invention.

The organic amines for use with the present invention can also be solvated, including hydrated. Hydration can occur during manufacturing of the organic amines, formulation of the molecular resists, or during storage, or the hydration can occur over time due to the hygroscopic nature of the compounds.

The organic amines for use with the present invention can also contain varying amounts of isotopes of carbon, hydrogen, nitrogen, oxygen, sulfur, halogen, etc.; such as ¹³C, ¹⁴C, deuterium, tritium, ¹⁵N, ¹⁸O, ¹²⁸I, etc. Some of the isotopic content is naturally occurring, but the organic amines for use with the present invention can be enriched or depleted in one or more of these. Thus, these isotopes or mixtures thereof are part of the invention.

When any variable occurs more than one time in any organic amine of Formula I, II, III, IV, V, VI or VII, unless otherwise indicated, its definition on each occurrence is independent of its definition at every other occurrence. Also, combinations of substituents and/or variables are permissible only if such combinations result in stable compounds.

Although detailed definitions have not been provided for every term used above, each term is understood by one of ordinary skill in the art.

In some embodiments, the organic amine is a compound chosen from:
4-(bis(4-aminophenyl)methylene)cyclohexa-2,5-dieniminium chloride;
4-(bis(4-amino-3-methylphenyl)methylene)-2-methylcyclohexa-2,5-dieniminium chloride;
N-(4-(bis(4-(dimethylamino)phenyl)methylene)cyclohexa-2,5-dienylidene)methanaminium chloride;
N-(4-(bis(4-(dimethylamino)phenyl)methylene)cyclohexa-2,5-dienylidene)-N-methylmethanaminium chloride;
N-(4-(bis(4-(diethylamino)phenyl)methylene)cyclohexa-2,5-dienylidene)-N-ethylethanaminium chloride;
4,4′,4″-methanetriyltris(N,N-dimethylaniline);
N-(9-carbamoyl-6,7-dihydroxy-3H-phenoxazin-3-ylidene)-N-ethylethanaminium chloride;
N-(9H-benzo[a]phenoxazin-9-ylidene)-N-methylmethanaminium chloride;
N-(7-(dimethylamino)-3H-phenothiazin-3-ylidene)-N-methylmethanaminium chloride;
9-acetamido-5H-benzo[a]phenoxazin-5-iminium chloride;
(Z)-1-((4-methyl-2-nitrophenyl)diazenyl)naphthalen-2-ol;
copper(II)phthalocyanine;
5,10,15,20-tetra(4-pyridyl)porphyrin;
4,4′,4″,4′″-(porphine-5,10,15,20-tetrayl)tetrakisbenzoic acid;
tris(4-aminophenyl)methanol;
sodium (Z)-3-(((4-((4-(diethylamino)phenyl)(4-(ethyl(3-sulfonatobenzyl)amino)phenyl)methylene)cyclohexa-2,5-dienylidene)(ethyl)ammonio)methyl)benzenesulfonate;
6-(dimethylamino)-3,3-bis(4-(dimethylamino)phenyl)iso-benzofuran-1(3H)-one; and combinations thereof.

In some embodiments, the organic amine is a compound chosen from: acid blue 25, acid blue 29, acid blue 40, acid blue 45, acid blue 80, acid blue 92, acid blue 119, acid blue 120, acid blue 129, acid black 24, acid black 48, acid fuchsin, basic fuchsin, new fuchsin, acid green 25, acid green 27, acid orange 8, acid orange 51, acid orange 63, acid orange 74, acid red 1, acid red 4, acid red 8, acid red 37, acid red 88, acid red 97, acid red 114, acid red 151, acid red 183, acid red 183, methyl violet, methyl violet B, methyl violet 2B, ethyl violet, acid violet, acid violet 1, acid violet 5, acid violet 6, acid violet 7, acid violet 9, acid violet 17, acid violet 20, acid violet 30, acid violet 34, acid alizarin violet N, acid yellow 14, acid yellow 17, acid yellow 25, acid yellow 42, acid yellow 76, acid yellow 99, basic violet 1, basic violet 3, benzyl violet 4B, Coomassie® violet R^{200,} crystal violet, leucocrystal violet, resorcin crystal violet, crystal violet lactone, direct violet 17, direct violet 38, direct violet 51, fast violet B, gentian violet, pararosaniline base, cresolphthalein complexone, cresyl violet acetate, cresyl violet perchlorate, cresyl violet perchlorate, iodonitrotetrazolium violet-formazan, methylene violet 3RAX, pyoktanin blue, pyrocatechol violet, remazol brilliant violet 5R, rhodamine B, tetrazolium violet, violamine R, fast red violet 1B base, iodonitrotetrazolium chloride, leuco patent blue violet, thionin acetate, calcomine violet N, disperse violet 13, disperse violet 17, disperse violet 28, phenol violet, pontachrome violet SW, reactive violet 5, vat violet 1, wool violet, erio chrome violet 5B, omega chrome dark violet D, leucomalachite green, and salts and ionomers thereof, and combinations thereof

Molecular resists of the present invention include solutions, suspensions, gels, creams, glues, adhesives, liquids, viscous liquids, semi-solids, powders, solids, and the like that can be disposed (e.g., poured, sprayed, deposited or otherwise applied) to a substrate.

In some embodiments, a molecular resist composition of the present invention comprises a solvent. Suitable solvents include those in which an organic amine of Formula I, II, III, IV, V, VI or VII has a solubility of about 0.005% by weight or greater, about 0.01% by weight or greater, about 0.05% by weight or greater, about 0.1% by weight or greater, about 0.5% by weight or greater, about 1% by weight or greater, or about 2% by weight or greater.

Solvents for use with the present invention include both non-polar and polar solvents, including both protic and aprotic solvents.

In some embodiments, a solvent suitable for use in the molecular resist is chosen from: water, C₁-C₈ alcohols (e.g., methanol, ethanol, propanol, butanol, and the like), C₆-C₁₂ straight chain, branched and cyclic hydrocarbons (e.g., hexane, cyclohexane, heptane, cyclooctane, decalin, and the like), C₅-C₁₄ aromatic solvents (e.g., pyridine, benzene, toluene, xylene, cumene, and the like), C₃-C₁₀ alkyl ketones (e.g., acetone, methylethylketone, diethylketone, and the like), C₃-C₁₀ esters (e.g., ethyl acetate, and the like), C₄-C₁₀ alkyl ethers (e.g., ethyleneglycol dimethylether, THF, and the like), alkyl, cycloalkyl, and aralkyl amides (e.g., N,N-dimethylformamide, N-methylpyrrolidone, and the like), chlorinated solvents (e.g., dichloromethane, chloroform, dichloroethane, chlorobenzene, and the like), and combinations thereof, and other solvents known to persons of ordinary skill in the art.

In some embodiments, a solvent is present in a molecular resist composition in a concentration of about 5% to about 99.99% by weight. In some embodiments, a solvent is present in a molecular resist composition in a maximum concentration of about 99.99%, about 99.95%, about 99.9%, about 99.5%, about 99%, about 98%, about 97%, about 95%, about 90%, or about 80% by weight of the molecular resist. In some embodiments, a solvent is present in a minimum concentration of about 5%, about 10%, about 25%, about 50%, about 75%, about 90%, about 95%, about 96%, about 97%, or about 98% by weight of the molecular resist composition.

In some embodiments, the molecular resist composition comprises a solid or a powder. For example, in some embodiments a molecular resist composition comprises a powder comprising an organic amine that is present in either dry form or suspended in a solvent and applied to a substrate in a pattern. The dry or wet powder can then be melted, dissolved, or otherwise activated to provide a pattern that forms a continuous coating on selected areas of the substrate.

In some embodiments, a molecular resist composition consists essentially of: an organic amine in a concentration of about 0.01% to about 5% by weight; a first solvent having a boiling point less than 100° C. in a concentration of about 80% by weight or greater; at least one second solvent having a boiling point of 100° C. or greater in a concentration of about 15% by weight or less; and an optional surfactant or stabilizer.

As used herein, “consisting essentially” refers to the molecular resist composition including one or more conductive organic amines, one or more first solvents, and one or more second solvents. Thus, the molecular resist composition of the present invention can include mixtures of organic amines, and multicomponent solvent mixtures so long as at least one of each component is present in the molecular resist composition.

In some embodiments, a solvent comprises a solvent mixture. Not being bound by any particular theory, a mixture of solvents in a molecular resist composition can in some embodiments provide advantages over a molecular resist composition comprising a single solvent. For example, solvent mixtures can be selected to balance any one of solubility, spreadability (i.e., wetting of a substrate by a molecular resist), drying speed, cost, stability of the composition, and the like. In some embodiments, a molecular resist composition comprises a first high-volatility solvent (i.e., a solvent having a vapor pressure of about 30 mm Hg or more at 25° C.) and at least one second low-volatility solvent (i.e., a solvent having a vapor pressure of about 30 mm Hg or less at 25° C.). A high-volatility solvent can be removed rapidly after disposition of the molecular resist to provide a composition particularly well-suited for high-throughput manufacturing. A low-volatility solvent that is more difficult to remove from the molecular resist can ensure that a pattern formed by the organic amine is continuous and free from pinholes, cracks, and other defects.

In some embodiments, the solvent comprises a first solvent having a boiling point less than 100° C. and at least one second solvent having a higher boiling point than the first solvent. In some embodiments, a first solvent is present in a molecular resist in a concentration of about 10% to about 90%, about 15% to about 85%, about 25% to about 85%, about 40% to about 80%, or about 50% to about 75% by weight. In some embodiments, a first solvent is present in a concentration of about 80% or greater, about 85% or greater, about 90% or greater, about 95% or greater, about 97% or greater, about 98% or greater, about 99% or greater, about 99.5% or greater, or about 99.9% or greater by weight of the molecular resist.

In some embodiments, at least one second solvent having a boiling point lower than the first solvent has a boiling point of about 100° C. or greater, about 120° C. or greater, about 125° C. or greater, about 130° C. or greater, about 135° C. or greater, about 140° C. or greater, about 150° C. or greater, or about 160° C. or greater. In some embodiments, at least one second solvent having a boiling point of 100° C. or greater present in a concentration of about 15% or less, about 10% or less, about 5% or less, about 2% or less, about 1% or less, about 0.5% or less, or about 0.1% or less by weight of the molecular resist.

In some embodiments, the solvent comprises a first solvent having a vapor pressure at 25° C. of about 30 mm Hg or more and at least one second solvent having a lower vapor pressure than the first solvent. In some embodiments, the first solvent has a vapor pressure at 25° C. of about 30 mm Hg or more, about 35 mm Hg or more, about 40 mm Hg or more, about 45 mm Hg or more, about 50 mm Hg or more, about 55 mm Hg or more, about 60 mm Hg or more, about 70 mm Hg or more, about 80 mm Hg or more, or about 100 mm Hg or more.

In some embodiments, a first solvent in the molecular resist composition is chosen from the non-limiting group of: methanol, ethanol, iso-propanol, straight, branched and cyclic hydrocarbons (e.g., benzene, hexane, cyclohexane, and the like), methylenechloride, chloroform, carbon tetrachloride, 1,2-dichloroethane, acetone, methylethylketone, ethylacetate, propylacetate, diethylether, tetrahydrofuran, and the like, and combinations thereof. In some embodiments, the first solvent is ethanol.

In some embodiments, the second solvent has a vapor pressure lower than the first solvent. In some embodiments, the second solvent has a vapor pressure at 25° C. of about 30 mm Hg or less, about 25 mm Hg or less, about 20 mm Hg or less, about 15 mm Hg or less, or about 10 mm Hg or less. In some embodiments, the second solvent is an aromatic solvent. Exemplary, non-limiting, second solvents having a vapor pressure at 25° C. of about 30 mm Hg or less include octane, decane, dodecane, diethylketone, tetralin, decalin, butylacetate, n-propanol, n-butanol, toluene, xylene, cumene, cymene, mesitylene, chlorobenzene, dichlorobenzene, and other substituted aromatic solvents, N-methylpyrrolidone, N,N-dimethylformamide, and the like, and other solvents known to persons of ordinary skill in the art. In some embodiments, at least one second solvent having a vapor pressure at 25° C. of about 30 mm Hg or less is present in a concentration of about 15% or less, about 10% or less, about 5% or less, about 2% or less, about 1% or less, about 0.5% or less, or about 0.1% or less by weight of the molecular resist.

In some embodiments, the molecular resist composition is formulated to control its viscosity. Parameters that can control viscosity include, but are not limited to, solvent composition, solvent concentration, the presence of functional groups (i.e., zwitterions, and the like) on the organic amine, and the like, and combinations thereof.

In some embodiments, a molecular resist composition has a viscosity of about 0.01 cP to about 1,000 cP, about 1 cP to about 500 cP, about 1 cP to about 100 cP, or about 1 cP to about 50 cP. In some embodiments, a molecular resist composition has a minimum viscosity of about 0.01 cP, about 0.1 cP, about 1 cP, about 2 cP, about 5 cP, about 10 cP, about 15 cP, about 20 cP, about 25 cP, about 30 cP, about 40 cP, or about 50 cP. In some embodiments, a molecular resist composition has a maximum viscosity of about 1,000 cP, about 500 cP, about 100 cP, about 75 cP, about 50 cP, about 25 cP, or about 10 cP. In some embodiments, a molecular resist has a tunable viscosity, and/or a viscosity that can be controlled by one or more external conditions.

In some embodiments, a molecular resist further comprises an optional surfactant. Surfactants suitable for use with the present invention include, but are not limited to, fluorocarbon surfactants that include an aliphatic fluorocarbon group (e.g., ZONYL® FSA and FSN fluorosurfactants, E.I. Du Pont de Nemours and Co., Wilmington, Del.); fluorinated alkyl alkoxylates (e.g., FLUORAD® surfactants, Minnesota Mining and Manufacturing Co., St. Paul, Minn.); hydrocarbon surfactants that have an aliphatic group (e.g., alkylphenol ethoxylates comprising an alkyl group having about 6 to about 12 carbon atoms, such as octylphenol ethoxylate, available as TRITON® X-100, Union Carbide, Danbury, Conn.); silicone surfactants such as silanes and siloxanes (e.g., polyoxyethylene-modified polydimethylsiloxanes such as Dow CORNING® Q2-5211 and Q2-5212, Dow Corning Corp., Midland, Mich.); fluorinated silicone surfactants (e.g., fluorinated polysilanes such as LEVELENE® 100, Ecology Chemical Co., Watertown Mass.); and combinations thereof, and any other surfactants known to a person of ordinary skill in the art. Not being bound by any particular theory, in some embodiments a surfactant can modify a property of a molecular resist to improve wetting of a substrate by an organic amine.

In some embodiments, a molecular resist further comprises an optional stabilizer. A “stabilizer” refers to a compound, molecule or species that can improve the stability of the molecular resist composition (e.g., by inhibiting degradation of the organic amine). A stabilizer can comprise a peroxide scavenging species, a free-radical scavenging species, a UV-absorbing species, a chelating species, and combinations thereof, and any other stabilizing compounds known to persons of ordinary skill in the art. Stabilizers suitable for use in the present invention include, but are not limited to, substituted alkyl and heteroalkyl species (e.g., biotin, carotenoids, adipic acid, alpha lipoic acid, ascorbyl palmitate, etc.), metallic species, substituted aryl and aralkyl species (e.g., tocopherols, butylated hydroxytoluene, butylated hydroxyanisole), ionic species (e.g., calcium citrate, sodium metabisulfate, etc.), and combinations thereof, and other stabilizers known to a person of ordinary skill in the art.

In some embodiments, the molecular resist compositions of the present invention are substantially free from excipients and the like that are typically present in ink compositions suitable for use in standard writing instruments such as pens. For example, in some embodiments the molecular resist compositions of the present invention are substantially free from de-foaming agents, capping agents, and the like.

The molecular resist compositions of the present invention provide benefits over inks comprising a SAM-forming species. Not being bound by any particular theory, the range of substrates that can be patterned with SAM-forming species is typically limited to substrates capable of forming a covalent bond with a SAM-forming monomer or species. Therefore, while SAMs can be readily formed on many metals, glasses, and the like, composite substrates can be particularly difficult to pattern using SAMs. Moreover, SAMs are prone to the formation of defects such as pinholes, grain boundary defects, areas of incomplete SAM coverage, and the like, and can also be easily damaged by contact. The molecular resists of the present invention are both chemically and mechanically more robust than SAMs, as is evidenced by the molecular resist compositions of the present invention displaying at least partial resistance to many wet etchant formulations that are capable of completely removing a SAM from a substrate. Additionally, SAMs frequently exhibit edge-dominance effects in which areas of a SAM pattern near proximate to an edge have a higher density. This can result in uneven etch resistance across different regions of a SAM pattern. On the other hand, patterns formed using the molecular etch resists of the present invention are generally uniform in thickness, thereby providing superior etch resistance. Moreover, because the molecular resists of the present invention adhere to substrates via a non-covalent interaction, a wide variety of substrates can be patterned using the molecular resists that are not capable of being patterned with SAMs.

The molecular resist compositions and patterns formed therefrom also provide advantages over SAMs that have been chemically amplified or reinforced. Not being bound by any particular theory, etch resist patterns formed by disposing a species on a SAM, wherein the deposition relies upon a non-covalent interaction such as a hydrophobic interaction results in patterns having rounded edges. In some embodiments, an etch resist pattern formed by self-aligned deposition on a SAM template results in the inability to form etched features (i.e., subtractive features) having 90° corners. On the other hand, the molecular resist patterns of the present invention permit the formation of features having any size or geometry including 90° corners, curves, and combinations thereof. Additionally, the molecular etch resist compositions of the present invention are capable of forming solid, robust thin films having greater stability than amplified SAM patterns. Additionally, thin films formed by the molecular etch resists of the present invention are typically thinner than amplified or reinforced SAM patterns, but exhibit greater etch resistance and stability.

The molecular resist compositions of the present invention also provide significant benefits over traditional polymer-based etch resists. Polymeric etch resists are typically deposited by blanket deposition methods such as spin-coating or spraying that require a flat or planar substrate. However, the molecular resist compositions of the present invention can be patterned on any substrate irrespective of geometry, curvature, and the like. Additionally, the molecular etch resists of the present invention can form a pattern via self-assembly, without the need for exposure using a costly lithographic apparatus. For example, the molecular etch resists of the present invention typically self-assemble in a pattern on a substrate due to a surface interaction such as a hydrophobic-hydrophilic interaction, and the like, in which a laterally defined functional group on a substrate is capable of directing the areas of a substrate that are covered or free from a molecular resist. Such deposition processes are typically not capable of using polymers. Additionally, the molecular resists of the present invention are typically single molecules or mixtures thereof that do not require special packaging, inhibition from polymerization, and the like. Therefore the molecular resist compositions of the present invention provide significant cost benefits over polymeric etch resists.

The present invention is also directed to a composition comprising: a substrate having a surface, and on the surface:
(a) a pattern comprising an organic amine, wherein the pattern has at least one lateral dimension of about 500 μm or less; and
(b) adjacent to the pattern, and covering the area of the surface not covered by the pattern, a thin film comprising a SAM-forming species.

In some embodiments, a pattern comprising an organic amine has an elevation of about 5 nm to about 100 μm on at least a portion of the substrate. In some embodiments, a pattern comprising an organic amine has a thickness (i.e., an elevation or vertical dimension) that is at least about 3 times greater, at least about 5 times greater, at least about 10 times greater, at least about 15 times greater, at least about 20 times greater, at least about 25 times greater, at least about 30 times greater, at least about 40 times greater, or at least about 50 times greater than the thickness of a thin film comprising a SAM-forming species.

A SAM pattern on a substrate, or a pattern comprising a surface functional group can be used to direct the deposition of a molecular resist pattern. Exposure of the patterned substrate to a reactive composition such as an etchant will result in modification of the areas of the substrate not protected (i.e., covered) by the molecular resist pattern.

The present invention is also directed to a composition comprising: a substrate having a surface including at least one etched indentation therein, the etched indentation forming a pattern in the surface having at least one lateral dimension of about 500 μm or less, and having on the raised areas of the pattern a thin film comprising an organic amine adhered to the substrate by a non-covalent interaction, wherein the etched indentation is free from the organic amine.

The sidewalls of the etched indentation can be vertical (i.e., orthogonal to the surface of the substrate), curved, and/or tapered. For indentations having tapered sidewalls, the sidewalls of the indentation can form an angle with the surface of the substrate of about 30° to about 150°, about 45° to about 135°, about 60° to about 120°, about 75° to about 105°, or about 85° to about 95°.

In some embodiments, the thin film or pattern comprising an organic amine does not penetrate or permeate into the substrate. The organic amine can be removed from the substrate using, for example, a solvent, a mechanical force, an adhesive, and the like.

Methods The present invention is directed to a method for patterning a substrate, the method comprising:
disposing on a substrate a molecular resist composition comprising an organic amine, wherein the organic amine adheres to the substrate by a non-covalent interaction in a pattern having at least one lateral dimension of about 500 μm or less; and
reacting a portion of the substrate not covered by the pattern to form a feature thereon, wherein the feature has a lateral dimension defined by the pattern.

As used herein, “disposing” refers to deposition, application, coating, printing and lithography processes capable of forming a molecular coating and/or pattern on a substrate. Disposing can include, but is not limited to, ink jet printing, writing, dip-pen lithographic printing, vapor deposition, aerosol deposition, sublimation, syringe deposition, spray coating, spin coating, brushing, and combinations thereof, and any other printing processes known to a person of ordinary skill in the art.

In some embodiments, disposing includes a templated deposition process such as, but not limited to, a soft lithographic process a stencil process, a screen-printing process, and the like. Soft lithographic process include, but are not limited to, microcontact printing, microtransfer molding, microtransfer molding in capillaries, and combinations thereof, and any other deposition processes using a stamp that are known to a person of ordinary skill in the art. As used herein, a “stamp” refers to a three-dimensional object having on at least one surface of the stamp an indentation that defines a pattern.

In some embodiments, disposing comprises stenciling, screen printing, shadow mask deposition, and combinations thereof. As used herein, a “stencil” refers to a three dimensional object having at least one opening that penetrates through two opposite surfaces of the object to form an opening there through. A molecular resist can be applied to a substrate in a pattern defined by an opening in a stencil by contacting a stencil with a substrate or by maintaining the stencil at a fixed location above the substrate, and disposing a molecular resist onto a substrate through the at least one opening in the stencil.

Stamps and stencils for use with the present invention are not particularly limited by geometry, and can be flat, curved, smooth, rough, wavy, and combinations thereof. The thickness of the stamp can be homogeneous or varied. In some embodiments, a stamp or a stencil can have a three dimensional shape suitable for conformally contacting a substrate. In some embodiments, the three-dimensional shape of a stamp is non-planar or curved and is specifically formed in the shape of a substrate to be patterned. A stamp or a stencil can comprise multiple patterned surfaces that comprise the same, or different patterns. In some embodiments, a stamp or a stencil comprises a cylinder wherein one or more indentations in the curved face of the cylinder define a pattern. As the cylindrical stamp or stencil is rolled across a substrate a molecular resist or a SAM-forming species is transferred from the stamp or through the stencil, and the pattern is repeated as the cylindrical stamp or stencil traverses a substrate. A molecular resist composition or a SAM-forming species can be applied to the outside or through a cylindrical stamp, or through a cylindrical stencil as it rotates. For stamps or stencils having multiple patterned surfaces: cleaning, applying, contacting, removing, and reacting can occur simultaneously on the different surfaces of the same stamp or stencil.

Stamps and stencils for use with the present invention are not particularly limited by materials, and can be prepared from materials such as, but not limited to, an elastomer (e.g., a poly(dialkylsiloxane) such as poly(dimethylsiloxane) (“PDMS”), a poly(silsesquioxane), polyisoprene, polybutadiene, a poly(acrylamide), poly(butylstyrene), polychloroprene, an acryloxy elastomer, a fluorinated or perfluorinated elastomer (e.g., TEFLON®, E. I. DuPont de Nemours & Co., Wilmington, Del.), copolymers thereof, and combinations thereof and those materials disclosed in U.S. Pat. Nos. 5,512,131; 5,900,160; 6,180,239 and 6,776,094, all of which are incorporated herein by reference in their entirety); a glass (e.g., quartz, sapphire, borosilicate glass, and the like); a ceramic (e.g., metal carbides, metal nitrides, metal oxides, and the like); a plastic; a metal; and combinations thereof; and any other materials known to a person of ordinary skill in the art.

An elastomeric stamp or stencil can further comprise a stiff, flexible, porous, or woven backing material, or any other means of preventing or minimizing deformation of the stamp or stencil during processes described herein.

Not being bound by any particular theory, disposing a molecular resist on a substrate can be promoted by one or more interactions between the molecular resist and the substrate, such as, but not limited to, gravity, a Van der Waals interaction, an ionic interaction, a hydrogen bond, a hydrophilic interaction, a hydrophobic interaction, a magnetic interaction, and combinations thereof.

In some embodiments, the method further comprises prior to the disposing, forming a primary pattern on an area of the substrate, wherein the primary pattern defines the at least one lateral dimension of the pattern. For example, a primary patterning can be formed by a pre-treating process. A pre-treating process can be applied uniformly to a substrate or selectively to a portion of a substrate (i.e., such that a primary pattern is formed on the substrate by the pre-treating process) and/or to a portion of a stamp or stencil used herein. The pre-treating processes suitable for use with the present invention include, but are not limited to, cleaning, oxidizing, reducing, derivatizing, functionalizing, texturing, charging, magnetizing, depositing a thin film, depositing a SAM-forming species, exposing to a reactive gas, exposing to a plasma, exposing to a thermal energy (e.g., convective thermal energy, radiant thermal energy, conductive thermal energy, and combinations thereof), exposing to an electromagnetic radiation (e.g., x-rays, ultraviolet light, visible light, infrared light, and combinations thereof), and combinations thereof, and other processes known to persons of ordinary skill in the art, any of which can be used to direct self-aligned deposition of the molecular resist composition on a substrate.

Not being bound by any particular theory, derivatizing a substrate with a polar functional group (e.g., oxidizing the surface) can promote the wetting of a surface by a molecular resist, for example, by a hydrophilic-hydrophilic interaction.

In some embodiments, a method of the present invention further comprises prior to the disposing, patterning a primary pattern on the substrate by a soft lithography method, wherein the primary pattern defines the area of the substrate onto which the molecular resist is disposed. The primary pattern adheres or bonds to the substrate, and can form a thin film, a monolayer, a bilayer, a SAM, and combinations thereof on the substrate.

In some embodiments, a primary pattern formed on the substrate has a surface characteristic such that the primary pattern is not readily wetted by a molecular resist disposed thereon. Thus, subsequent disposition of the molecular resist on the substrate comprising the primary pattern by, e.g., spraying, dip-coating, chemical vapor depositing, brushing, spin-coating, atomizing, aerosolizing, doctor-blading, wiping, and the like, provides a self-aligned molecular resist pattern on the substrate whereby the molecular resist is selectively disposed on areas not covered by the first pattern.

As used herein, a “surface characteristic” refers to the chemical functionality of the surface of a pattern. Most generally, the chemical functionality of the pattern can be hydrophilic or hydrophobic. As used herein, hydrophilic surfaces are those on which water forms a contact angle, Θ, wherein Θ≦90°. As used herein, hydrophobic surfaces are those on which water forms a contact angle, Θ, wherein Θ>90°. Hydrophilic surfaces can further comprise: hydrogen-bond donating surfaces, hydrogen-bond receiving surfaces, chemically reactive surfaces, and combinations thereof. As used herein, a hydrogen-bond donating surface has an exposed functional group containing an —NHₓ or —OH group, wherein x is 1 or 2. As used herein, a hydrogen-bond receiving surface has a functional group containing an exposed N, O, or F atom having a lone pair of electrons. As used herein, a chemically reactive surface has an exposed functional group other than an alkyl, fluoroalkyl or perfluoroalkyl group.

Functional groups suitable for imparting hydrophobicity to a surface pattern include: but are not limited to, halo, perhalo, and unsubstituted: alkyl, alkenyl, alkynyl, aryl, arylalkyl, heterocyclyl, and alkylsilyl groups (as defined above), and combinations thereof. Substituted alkyl, alkenyl, alkynyl, aryl, arylalkyl, heterocyclyl, and alkylsilyl groups (as defined above), can also be suitable for imparting hydrophobicity to a surface pattern, wherein the functional groups present in the material are not exposed at the surface of the pattern. For example, hydrogen-bond donating and accepting groups, and the like, can be present in the backbone of a material having a hydrophobic surface.

As used herein, “halo,” by itself or as part of another group, refers to any of the above alkyl, alkenyl, alkynyl, aryl, aralkyl, and heterocyclyl groups wherein one or more hydrogens thereof are substituted by one or more fluorine, chlorine, bromine, or iodine atoms.

As used herein, “perhalo,” by itself or as part of another group, refers to any of the above alkyl, alkenyl, alkynyl, aryl, aralkyl, and heterocyclyl groups wherein all of the hydrogens thereof are substituted by fluorine, chlorine, bromine, or iodine atoms.

Not being bound by any particular theory, self-aligned deposition processes can be provided by a hydrophilic-hydrophilic interaction between the molecular resist and a substrate, a static charge interaction between the molecular resist and the substrate, and the like.

In some embodiments, the primary pattern comprises a SAM-forming species. As used herein, a “SAM-forming species” refers to a molecule, compound, moiety, and the like capable of forming a self-assembled monolayer on a substrate. A primary pattern comprising a SAM-forming species can be formed, for example, by contacting the substrate with a stamp having a surface including at least one indentation therein, and wherein the contacting transfers a SAM-forming species from the surface of the stamp to the substrate to form a primary pattern thereon having a lateral dimension defined by the at least one indentation, as described in, e.g., U.S. Pat. No. 5,512,131, which is incorporated herein by reference in its entirety. The primary pattern formed by the SAM-forming species need not be a fully dense monolayer. For example, the primary pattern can comprise a partial monolayer, a monolayer comprising defects therein, and the like. In some embodiments, a partial monolayer can be back-filled with a second pattern-forming species that adheres to the monolayer. However, the primary pattern can include multiple defects such that it would not itself be etch resistant.

After a primary pattern is formed, a molecular resist is applied to the substrate, wherein the molecular resist is selectively disposed on an area of the substrate not covered by a primary pattern.

Thus, in some embodiments the present invention is also direct to a method for patterning a substrate, the method comprising:
contacting a substrate with a stamp having a surface including at least one indentation therein to provide a first pattern on the substrate defined by the at least one indentation;
disposing on the substrate a molecular resist composition comprising an organic amine, wherein the organic amine adheres by a non-covalent interaction to an area of the substrate not covered by the first pattern; and
etching the area of the substrate covered by the first pattern to form a feature thereon.

The method of the present invention further comprises reacting a portion of the substrate not covered by the molecular resist pattern to form a feature thereon, wherein the feature has a lateral dimension defined by the molecular resist pattern. As used herein, “reacting” refers to initiating a chemical reaction between a reactive composition and a substrate. Not being bound by any particular theory, reacting results in the formation of features on a substrate that can be formed by at least one of: reacting the components of a reactive composition with one other, reacting a component of a reactive composition with a surface of a substrate, reacting a component of a reactive composition with sub-surface region of a substrate, and combinations thereof. Thus, methods of the present invention comprise reacting a reactive composition not only with a surface of a substrate, but also with a region of a substrate below its surface, thereby forming inset or inlaid features.

The reacting modifies one or more properties of substrate, wherein the change in properties is localized to the portion of the substrate that reacts with the reactive composition. For example, a reactive metal particle can penetrate into the surface of a substrate, and upon reacting with the substrate, modify its conductivity. In some embodiments, a reactive component can penetrate into a substrate and react selectively to increase the porosity of the substrate in the areas (volumes) where reaction occurs. In some embodiments, a reactive component can selectively react with a crystalline substrate to increase or decrease its volume, or change the interstitial spacing of a crystalline lattice. In some embodiments, reacting an area of the substrate not covered by the molecular resist composition comprises chemically reacting a functional group on the surface of a substrate, wherein no penetration and reaction with a substrate occurs below the surface. In some embodiments, a reactive composition can undergo cross-linking or other reactions to form a continuous layer on the areas of the substrate lacking the organic amine.

In some embodiments, reacting comprises reactions that propagate into the plane (i.e., body) of a substrate, as well as reactions in the lateral plane of a surface of the substrate. For example, a reaction between an etchant and a substrate can comprise the etchant penetrating into the substrate (i.e., orthogonal to a surface), such that the lateral dimensions of a lowest point of the feature are approximately equal to a dimensions of the feature at the surface of the substrate.

In some embodiments, reacting comprises exposing the patterned substrate to a reactive composition (i.e., reacting the substrate is initiated upon contact between a reactive composition and a surface of a substrate). In some embodiments, reacting comprises exposing a reactive composition on a substrate to a reaction initiator. Reaction initiators suitable for use with the present invention include, but are not limited to, thermal energy, electromagnetic radiation, acoustic waves, an oxidizing or reducing plasma, an electron beam, a stoichiometric chemical reagent, a catalytic chemical reagent, an oxidizing gas, a reducing gas, an acid or a base (e.g., a decrease or increase in pH), an increase or decrease in pressure, an alternating or direct electrical current, agitation, sonication, friction, and combinations thereof. In some embodiments, reacting comprises exposing a reactive composition to multiple reaction initiators. Electromagnetic radiation suitable for use with the present invention can include, but is not limited to, microwave light, infrared light, visible light, ultraviolet light, x-rays, radiofrequency, and combinations thereof.

A reactive composition comprises a species that has a chemical interaction with a substrate. Reactive components include: etchants, reactive components, conductors, insulators, and combinations thereof.

As used herein, a “reactive component” refers to a compound, molecule, species, ion, or material that penetrates and/or diffuses into a substrate from a surface of the substrate, thereby locally modifying one or more properties of the substrate. Such modifications can occur at the surface or within a volume of the substrate. Reactive components include, but are not limited to, ions, free radicals, metals, acids, bases, metal salts, organic reagents, and combinations thereof. In some embodiments, a reactive component is present in a reactive composition in a concentration of about 1% to about 100% by weight.

In some embodiments, the reacting comprises etching. As used herein, an “etchant” refers to a component that can react with a substrate to remove a portion of the substrate. Thus, an etchant is used to form a subtractive feature, and in reacting with a substrate, forms at least one of a volatile material that can diffuse away from the substrate, or a residue, particulate, or fragment that can be removed from the substrate by, for example, a rinsing or cleaning process. In some embodiments, an etchant is present in a reactive composition in a concentration of about 2% to about 80%, about 5% to about 75%, or about 10% to about 75% by weight.

The composition and/or morphology of a substrate that can react with an etchant is not particularly limited. Subtractive features formed by reacting an etchant with a substrate are also not particularly limited so long as the material that reacts with the etchant can be removed from the resulting subtractive feature. Not being bound by any particular theory, an etchant can remove material from a surface by reacting with the substrate to form a volatile product, a residue, a particulate, or a fragment that can, for example, be removed from the substrate by a rinsing or cleaning process. For example, in some embodiments an etchant can react with a metal or metal oxide surface to form a volatile fluorinated metal species. In some embodiments, an etchant can react with a substrate to form an ionic species that is water soluble. Additional processes suitable for removing a residue or particulate formed by reaction of an etchant with a surface are disclosed in U.S. Pat. No. 5,894,853, which is incorporated herein by reference in its entirety.

Etchants suitable for use with the present invention include, but are not limited to, iodine, chlorine, fluorine, cyanide, boron trifluoride, boron trichloride, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, sodium hydroxide, potassium hydroxide, ammonium hydroxide, tetraalkylammonium hydroxide ammonia, ethanolamine, ethylenediamine, sulfuric acid, trifluoromethanesulfonic acid, fluorosulfonic acid, trifluoroacetic acid, hydrofluoric acid, hydrochloric acid, carborane acid, salts thereof, aqueous solutions thereof, and combinations thereof, as well as any other etchants known to a person of ordinary skill in the electronics, materials science and/or chemistry arts.

In some embodiments, a reactive composition further comprises a conductor. As used herein, a “conductor” refers to a compound, molecule, material, compound or species that can transfer or move electrical charge. Conductors suitable for use with the present invention include, but are not limited to, a metal, a nanoparticle, a polymer, a cream solder, a resin, and combinations thereof. In some embodiments, a conductor is present in a reactive composition in a concentration of about 1% to about 90% by weight.

Metals suitable for use with the present invention include, but are not limited to, a transition metal, aluminum, silicon, phosphorous, gallium, germanium, indium, tin, antimony, lead, bismuth, alloys thereof, and combinations thereof In some embodiments, a metal is present as a micron or sub-micron particle or a mixture thereof (i.e., a particle having a diameter of about 0.5 μm to about 2 μm), or a nanoparticle (i.e., a particle having a diameter of about 100 nm or less, or about 0.5 nm to about 100 nm). Nanoparticles suitable for use with the present invention can be homogeneous, multilayered, functionalized, and combinations thereof.

Conductive polymers suitable for use with the present invention include, but are not limited to, an arylene vinylene polymer, a polyphenylenevinylene, a polyacetylene, a polythiophene, a polyimidazole, substituted derivatives thereof, and combinations thereof, and any other conductive polymers known to a person of ordinary skill in the art.

In some embodiments, a reactive composition further comprises an insulator. As used herein, an “insulator” refers to a compound or species that is resistant to the movement or transfer of electrical charge. In some embodiments, an insulator has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulators suitable for use with the present invention include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, and combinations thereof. In some embodiments, an insulator is present in a reactive composition in a concentration of about 1% to about 80% by weight.

In some embodiments, a reactive composition further comprises a masking component. As used herein, a “masking component” refers to a compound, material, or species that upon contacting a substrate forms a feature resistant to a species capable of reacting with the surrounding substrate, and which is different from the molecular resist composition of the present invention (i.e., a polymeric, metal, or ceramic etch resist or mask). Masking components suitable for use with the present invention include materials commonly employed in traditional photolithography methods as “resists” (e.g., photoresists). Masking components suitable for use with the present invention include, but are not limited to, cross-linked aromatic and aliphatic polymers, non-conjugated aromatic polymers and copolymers, polyethers, polyesters, copolymers of C₁-C₈ alkyl methacrylates and acrylic acid, copolymers of paralyne, and combinations thereof. In some embodiments, a masking component is present in a reactive composition in a concentration of about 5% to about 98% by weight.

In some embodiments, a reactive composition comprises an etchant and a conductor. For example, an etchant present in a reactive composition can promote at least one of: penetration of a conductor into a substrate, reaction between a conductor and a substrate, adhesion between a conductor and a substrate, promoting electrical contact between a conductive feature and a substrate, and combinations thereof. Features formed by reacting such a reactive composition include conductive features chosen from: additive non-penetrating, additive penetrating, subtractive penetrating, and conformal penetrating features. In some embodiments, a reactive composition comprising an etchant and a conductor can be used to produce a subtractive feature having a conductive feature inset therein.

In some embodiments, a reactive composition comprises a reactive component and an insulator. For example, a reactive component present in a reactive composition can promote at least one of: penetration of an insulator into a substrate, reaction between an insulator and a substrate, adhesion between an insulating feature and a substrate, promoting electrical contact between an insulating feature and a substrate, and combinations thereof. Features formed by reacting such a reactive composition include insulating features chosen from: additive non-penetrating, additive penetrating, subtractive penetrating, and conformal penetrating features.

In some embodiments, a reactive composition comprises an etchant and an insulator, for example, that can be used to produce a subtractive feature having an insulating feature inset therein.

In some embodiments, a reactive composition comprises a conductor and a masking component, for example, that can be used to produce electrically conductive masking features on a substrate.

In some embodiments, a method of the present invention further comprises: exposing an area of a substrate adjacent to a feature to a reactive component that reacts with the adjacent surface area, but which is unreactive towards the feature. For example, after producing a feature comprising a masking component, the substrate can be exposed to an etchant, such as a gaseous etchant, a liquid etchant, and combinations thereof.

In some embodiments, the method further comprises: after the reacting, removing the molecular resist from the surface. For example, the molecular resist can be dissolved (e.g., using a solvent), physically removed from the substrate (e.g., scraped, etc.), volatilized (e.g., the substrate can be heated, and/or the molecular resist can be reacted to produce volatile species, and the like), chemically degraded, and combinations thereof, and other removal methods known to a person of ordinary skill in the art. After removing the molecular resist the resulting patterned substrate comprises a pattern having lateral dimensions that are determined by the pattern in the surface of the elastomeric stamp used to apply the ink to the substrate, as well as any patterns transferred to the substrate during the molecular deposition process.

The present invention is also directed to process products prepared by the methods described herein. Products prepared by the method described herein include, but are not limited to, electronic elements, optical elements, fabrics, display devices, packaging, and the like.

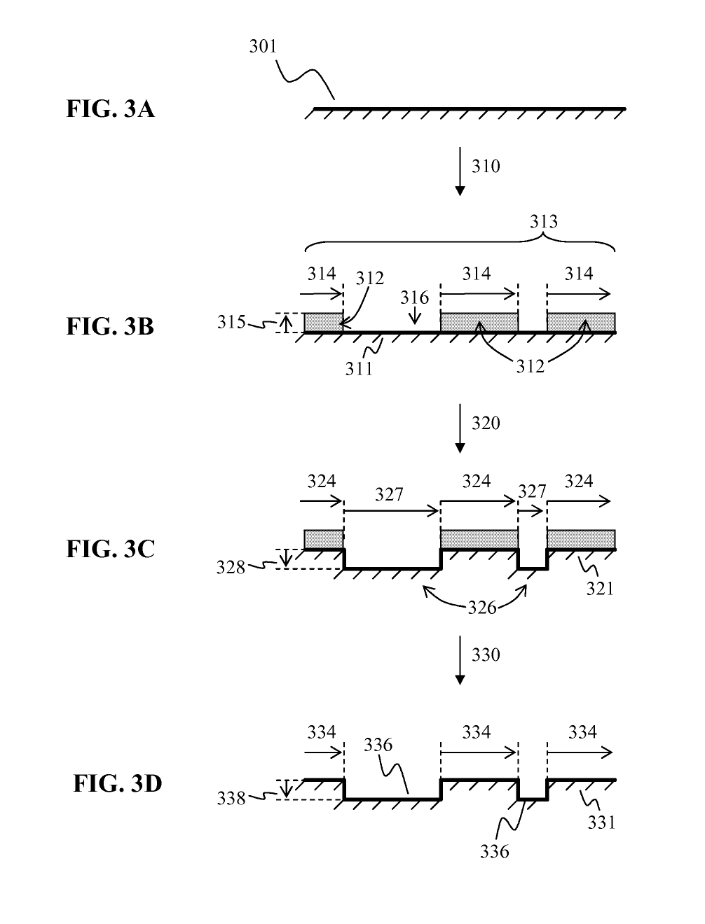

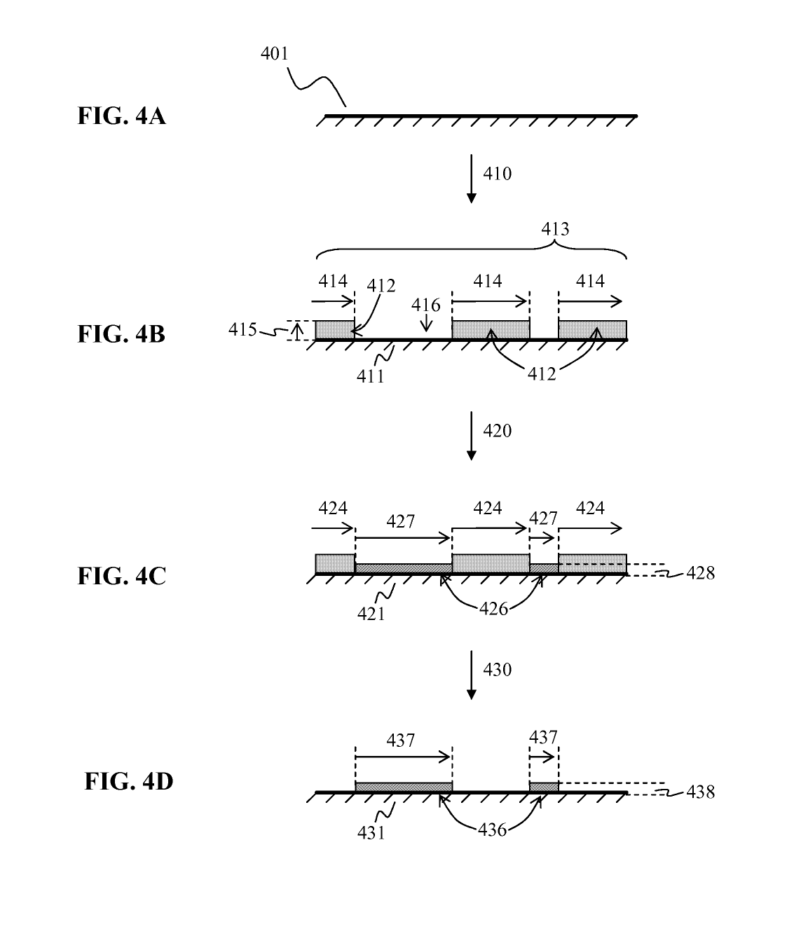

FIGS. 3A-3D and 4A-4D display schematic cross-sectional representations of embodiments of the process of the present invention. Referring to FIGS. 3A-3B and 4A-4B, an unmasked substrate, 301 and 401, respectively, is provided and a molecular resist is applied thereto, 310 and 410, respectively. The molecular resist composition comprising an organic amine, 312 and 412, respectively, forms a pattern, 313 and 413, respectively, on the substrate, 311 and 411, respectively. The pattern has a lateral dimension, 314 and 414, respectively, and a vertical dimension (i.e., elevation), 315 and 415, respectively. The molecular resist pattern provides at least a portion of the substrate, 316 and 416, respectively, that is not covered by the molecular resist. The substrate is then reacted, 320 and 420, respectively.

Referring to FIG. 3C, the substrate has been reacted with a reactive composition comprising an etchant. The substrate, 321, comprises a subtractive non-penetrating feature, 326, having a lateral dimension, 327, and an elevation, 328. The lateral dimensions of the features, 327, are defined by the lateral dimensions of the molecular resist pattern, 324. In some embodiments, the present invention is directed to a composition described in FIG. 3C: a substrate having a surface including at least one etched indentation therein, the etched indentation forming a pattern in the surface having at least one lateral dimension of about 500 μm or less, and having on the raised areas of the pattern a molecular resist composition comprising an organic amine, wherein the organic amine is not covalently attached to the substrate, and wherein the etched indentation is free from the organic amine. The lateral dimension of the at least one etched indentation is controlled by the lateral dimension of the pattern comprising the molecular etch resist of the present invention. In some embodiments, the lateral dimensions of features formed by the methods of the present invention are limited only by the lateral dimensions of patterns formed by the molecular etch resists. The organic amine can be optionally removed from the substrate, 330. The removing can comprises washing, wiping, mechanically removing, dissolving, and the like, and other removing processes known to persons of ordinary skill in the art.

Referring to FIG. 3D, a substrate, 331, having a subtractive non-penetrating feature, 336, is provided, the feature having a lateral dimension, 334, and a vertical dimension, 338.

Referring to FIG. 4C, the substrate has been reacted with a reactive composition to provide an additive, non-penetrating feature thereon. The substrate, 421, comprises additive non-penetrating features, 426, having a lateral dimension, 427, and an elevation, 428. The lateral dimensions of the features, 427, are defined by the lateral dimensions of the molecular resist pattern, 424. The molecular resist can be optionally removed from the substrate, 430.

Referring to FIG. 4D, a substrate, 431, having an additive non-penetrating feature, 436, is provided, the feature having a lateral dimension, 434, and an elevation, 438.

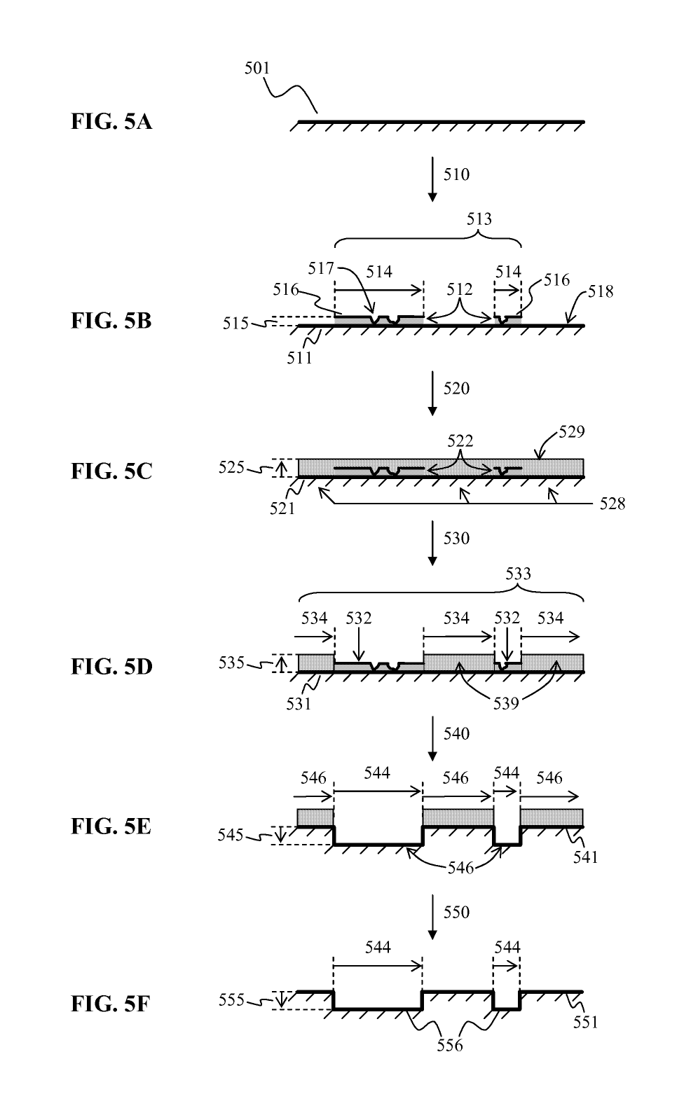

FIGS. 5A-5E display a schematic cross-sectional representation of an embodiment of the process of the present invention. Referring to FIG. 5A-5B, an unmasked substrate, 501, is provided and then pre-treated to form a pattern thereon, 510. The pre-treated substrate, 511, includes a first pattern thereon, 513, comprising a first material, 512. The pattern, 513, has a lateral dimension, 514, and an vertical dimension (i.e., elevation), 515. The pattern has a surface characteristic, 516, such as, but not limited to a hydrophobic surface characteristic. In some embodiments, the pattern, 512, is a SAM. The pattern can comprise one or more defects, 517, that can include point defects, pinhole defects, grain boundary defects, and combinations thereof. At least a portion of the substrate, 518, is not covered by the first pattern. After forming the pattern comprising a first material on the unmasked substrate, a molecular resist is applied to the substrate, 520.

Referring to FIG. 5C, a molecular resist, 529, has been applied to the substrate, 521. In some embodiments, the molecular resist is applied at a thickness, 525, to cover or coat the first pattern, 522. The molecular resist can also be selectively applied only to areas of the substrate not covered by the first pattern, 528. The molecular resist then interacts with the first pattern, 530.

Referring to FIG. 5D, a molecular resist, 539, has been disposed onto the substrate, 531, and formed a pattern, 533, thereon by self-alignment (i.e., an interaction between the molecular resist and a first material disposed on the substrate, 532). The molecular resist has a vertical dimension (i.e., an elevation), 535, and a lateral dimension, 536. In some embodiments, the present invention is directed to the composition provided by FIG. 5D: a composition comprising: a substrate having a surface, and on the surface: (a) a pattern comprising a molecular resist that has at least one amine group, wherein the pattern has at least one lateral dimension of about 500 μm or less; and (b) adjacent to the pattern, and covering the area of the surface not covered by the pattern, a thin film comprising a SAM. The substrate is then reacted with a reactive composition, 540.

Referring to FIG. 5E, the substrate has been reacted with a reactive composition comprising an etchant. The substrate, 541, comprises a subtractive non-penetrating feature, 546, having a lateral dimension, 544, and an elevation, 545. The lateral dimensions of the features, 544, are defined by the lateral dimensions of the molecular resist pattern, 546. The first pattern, 532 in FIG. 5D, was dissolved, destroyed, or otherwise removed from the substrate during the reacting.

Referring to FIG. 5F, a substrate, 551, having a subtractive non-penetrating feature, 556, is provided, the feature having a lateral dimension, 554, and an vertical dimension, 555.

### Examples

### Example 1

An elastomeric stamp was prepared from PDMS using a master. The patterned PDMS stamp included a surface having various rectilinear indentations therein, the indentations having a lateral dimension of about 500 μm to about 1 mm. The surface of the stamp was immersed in a monolayer-forming ink (a solution of 100 mM hexadecanethiol in acetone) for 15 seconds. The inked stamp was blown dry with nitrogen (15 seconds drying time), and the inked and dried surface of the stamp was applied to a composite substrate having a metal surface layer thereon (70 nm thick gold over poly(ethyleneterphthalate) “PET”, composite substrates available from, e.g., CP Films, Inc., Fieldale, Va.). The hexadecanethiol formed a primary pattern or “template” comprising a SAM on areas of the composite substrate that contacted the stamp surface. Areas on the substrate that corresponded to the pattern of indentations were not patterned with the SAM (i.e., the surface remained clean). A molecular resist composition of 0.07% by weight basic fuschin (4-(bis(4-aminophenyl)methylene)cyclohexa-2,5-dieniminium chloride), STR. 1, in ethanol was then applied to the substrate by immersing the templated surface for 1 minute in the molecular resist composition. The molecular resist composition initially coated the entire surface of the composite substrate.

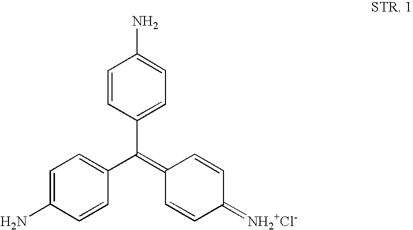

The molecular resist was then dried for 1 minute on a hotplate set at 80° C. The molecular resist composition began to de-wet the templated areas of the substrate, and preferentially wet the metal areas of the substrate. Thus, the molecular resist coated the areas of the substrate not covered by the primary pattern comprising a SAM. The patterned substrate was reacted with a reactive composition by immersion in a KI/I₂-based etchant (i.e., TRANSENE® TFA gold etchant, Transene Co., Inc., Danvers, Mass.) solution for 11 seconds. The substrate was then rinsed with acetone and dried with dry nitrogen. The reaction produced subtractive penetrating features on the substrate corresponding to the pattern of indentations in the surface of the stamp (i.e., gold was selectively removed from only those areas of the substrate that were coated with the hexadecanethiol SAM template). Areas of the substrate covered by the molecular resist were not etched. The molecular resist composition comprising basic fuschin (STR. 1) provided excellent contrast, excellent substrate wetting and template de-wetting and excellent edge resolution. As used herein, “contrast” refers to the degree of etch resistance provided by the molecular resist, “de-wetting” refers to the extent to which the SAM pattern (i.e., the template) was de-wetted by the molecular resist, and “edge-resolution” refers to the ability of the molecular resist to protect against horizontal etching from the edges of the molecular resist pattern.

### Example 2

Subtractive non-penetrating features were formed on a composite substrate as described in Example 1, except that a molecular resist composition comprising 0.07% by weight new fuschin (4-(bis(4-amino-3-methylphenyl)methylene)-2-methylcyclohexa-2,5-dieniminium chloride), STR. 2, in ethanol was employed.

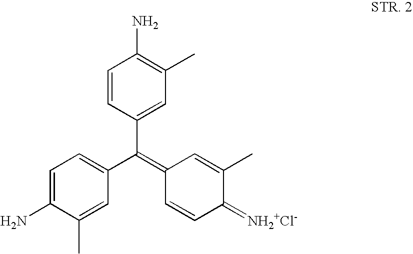

The gold layer was selectively removed from the areas of the substrate coated with the hexadecanethiol SAM template. The gold layer was not etched from areas of the substrate covered by the molecular resist. The molecular resist composition comprising new fuschin (STR. 2) provided excellent contrast, excellent substrate wetting and template de-wetting and excellent edge resolution, but some pinholes in the gold substrate were formed during the reacting.

### Example 3

Subtractive non-penetrating features were formed on a composite substrate as described in Example 1, except that a molecular resist composition comprising 0.07% by weight methyl violet 2B (N-(4-(bis(4-(dimethylamino)phenyl)methylene)cyclohexa-2,5-dienylidene)methanaminium chloride), STR. 3, in ethanol was employed.

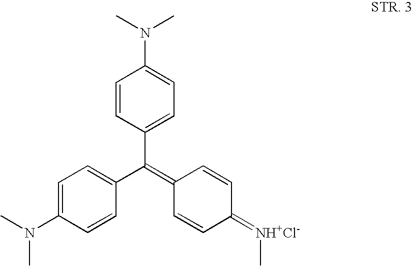

The gold layer was selectively removed from the areas of the substrate coated with the hexadecanethiol SAM template. The gold layer was not etched from areas of the substrate covered by the molecular resist. The molecular resist composition comprising methyl violet 2B (STR. 3) provided excellent contrast, excellent substrate wetting and template de-wetting and excellent edge resolution.

### Example 4

Subtractive non-penetrating features were formed on a composite substrate as described in Example 1, except that a molecular resist composition comprising 0.07% by weight crystal violet (N-(4-(bis(4-(dimethylamino)phenyl)methylene)cyclohexa-2,5-dienylidene)-N-methylmethanaminium chloride), STR. 4, in ethanol was employed.

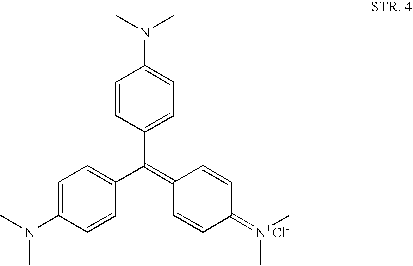

The gold layer was selectively removed from the areas of the substrate coated with the hexadecanethiol SAM template. The gold layer was not etched from areas of the substrate covered by the molecular resist. The molecular resist composition comprising crystal violet (STR. 4) provided excellent contrast, excellent substrate wetting and template de-wetting and excellent edge resolution.

### Example 5

Subtractive non-penetrating features were formed on a composite substrate as described in Example 1, except that a molecular resist composition comprising 0.07% by weight ethyl violet (N-(4-(bis(4-(diethylamino)phenyl)methylene)cyclohexa-2,5-dienylidene)-N-ethylethanaminium chloride), STR. 5, in ethanol was employed.

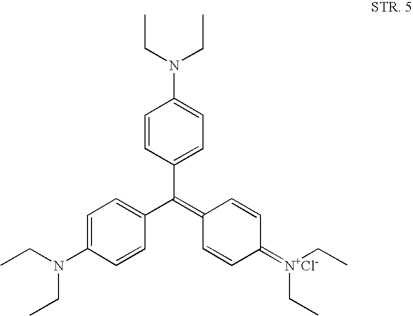

The gold layer was selectively removed from the areas of the substrate coated with the hexadecanethiol SAM template. The gold layer was not etched from areas of the substrate covered by the molecular resist. The molecular resist composition comprising ethyl violet (STR. 5) provided moderate contrast, good de-wetting and good edge resolution, but many pinholes in the gold substrate were formed during the reacting.

### Example6

Subtractive non-penetrating features were formed on a composite substrate as described in Example 1, except that a molecular resist composition comprising 0.07% by weight leuco crystal violet (4,4′,4″-methanetriyltris(N,N-dimethylaniline)), STR. 6, in ethanol was employed.

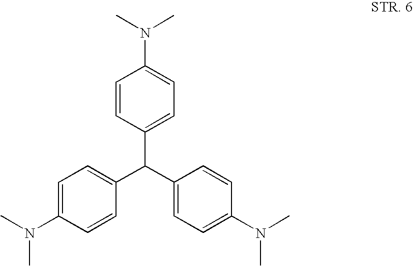

The gold layer was selectively removed from the areas of the substrate coated with the hexadecanethiol SAM template. The gold layer was not etched from areas of the substrate covered by the molecular resist. The molecular resist composition comprising leuco crystal violet (STR. 6) provided excellent contrast, excellent substrate wetting and template de-wetting and excellent edge resolution.

### Example7

Subtractive non-penetrating features were formed on a composite substrate as described in Example 1, except that a molecular resist composition comprising 0.07% by weight celestine blue (N-(9-carbamoyl-6,7-dihydroxy-3H-phenoxazin-3-ylidene)-N-ethylethanaminium chloride), STR. 7, in ethanol was employed.

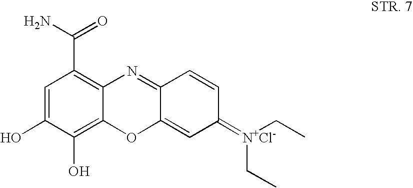

The gold layer was selectively removed from the areas of the substrate coated with the hexadecanethiol SAM template. The gold layer was not etched from areas of the substrate covered by the molecular resist. The molecular resist composition comprising celestine blue (STR. 7) provided excellent contrast, moderate template de-wetting and substrate wetting, and very good edge resolution. The moderate de-wetting was evidenced by splotches of un-etched gold that remained on the substrate in areas patterned by the SAM.

### Example8

Subtractive non-penetrating features were formed on a composite substrate as described in Example 1, except that a molecular resist composition comprising 0.07% by weight meldola's blue (N-(9H-benzo[a]phenoxazin-9-ylidene)-N-methylmethanaminium chloride), STR. 8, in ethanol was employed.

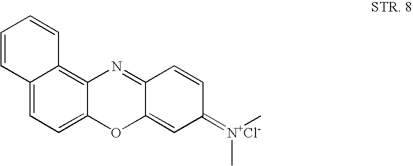

The gold layer was selectively removed from the areas of the substrate coated with the hexadecanethiol SAM template. The gold layer was not etched from areas of the substrate covered by the molecular resist. The molecular resist composition comprising meldola's blue (STR. 8) provided good contrast, excellent template de-wetting, moderate substrate wetting, and moderate edge resolution.

### Example9

Subtractive non-penetrating features were formed on a composite substrate as described in Example 1, except that a molecular resist composition comprising 0.07% by weight methylene blue (N-(7-(dimethylamino)-3H-phenothiazin-3-ylidene)-N-methylmethanaminium chloride), STR. 9, in ethanol was employed.

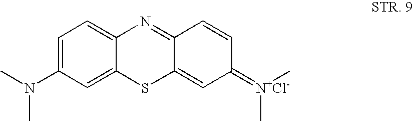

The gold layer was selectively removed from the areas of the substrate coated with the hexadecanethiol SAM template. The gold layer was not etched from areas of the substrate covered by the molecular resist. The molecular resist composition comprising methylene blue (STR. 9) provided excellent contrast, poor template de-wetting and very good edge resolution. The poor de-wetting was evidenced by splotches of un-etched gold areas that remained on the substrate in areas patterned by the SAM.

### Example 10

Subtractive non-penetrating features were formed on a composite substrate as described in Example 1, except that a molecular resist composition comprising 0.07% by weight darrow red (9-acetamido-5H-benzo[a]phenoxazin-5-iminium chloride), STR. 10, in ethanol was employed.

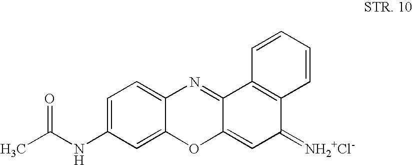

The gold layer was selectively removed from the areas of the substrate coated with the hexadecanethiol SAM template. The gold layer was not etched from areas of the substrate covered by the molecular resist. The molecular resist composition comprising darrow red (STR. 10) provided moderate contrast, excellent template de-wetting, moderate substrate wetting, and good edge resolution.

### Example 11

A substrate was patterned using the conditions described in Example 1, except that a molecular resist composition comprising 0.07% by weight toluidine red ((z)-1-((4-methyl-2-nitrophenyl)diazenyl)naphthalen-2-ol), STR. 11, in ethanol was employed.

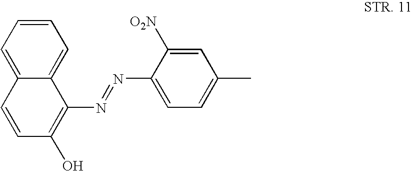

The gold layer was removed from the areas of the substrate coated with the hexadecanethiol SAM template. The gold layer was also to a large extent etched from areas of the substrate coated by the molecular resist. The molecular resist composition comprising toluidine red (STR. 11) provided poor contrast. The other evaluation parameters were not observed.

### Example 12

A substrate was patterned using the conditions described in Example 1, except that a molecular resist composition comprising 0.07% by weight copper(II)phthalocyanine, STR. 12, in ethanol was employed.

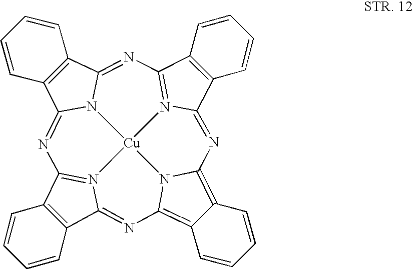

The gold layer was selectively removed from the areas of the substrate coated with the hexadecanethiol SAM template. The gold layer was also to a large extent etched from areas of the substrate coated by the molecular resist. The molecular resist composition comprising copper(II)phthalocyanine (STR. 12) provided poor contrast. The other evaluation parameters were not observed.

### Example 13

A substrate was patterned using the conditions described in Example 1, except that a molecular resist composition comprising 0.07% by weight 5,10,15,20-tetra(4-pyridyl)porphyrin, STR. 13, in ethanol was employed.

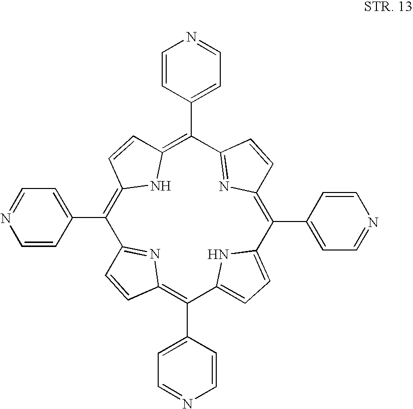

The gold layer was removed from the areas of the substrate coated with the hexadecanethiol SAM template. The gold layer was also to a large extent etched from areas of the substrate coated by the molecular resist. Thus, the molecular resist composition comprising STR. 13 provided poor contrast. The other evaluation parameters were not observed.

### Example 14

A substrate was patterned using the conditions described in Example 1, except that a molecular resist composition comprising 0.07% by weight 4,4′,4″,4′″-(porphine-5,10,15,20-tetrayl)tetrakis-benzoic acid, STR. 14, in ethanol was employed.

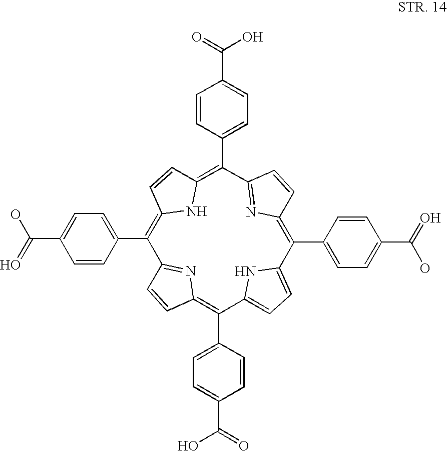

The gold layer was removed from the areas of the substrate coated with the hexadecanethiol SAM template. The gold layer was also to a large extent etched from areas of the substrate coated by the molecular resist. Thus, the molecular resist composition comprising STR. 14 provided poor contrast. The other evaluation parameters were not observed.

### Example 15

Subtractive non-penetrating features were formed on a composite substrate as described in Example 1, except that a molecular resist composition comprising 0.07% by weight pararosaniline base (tris(4-aminophenyl)methanol), STR. 15, in ethanol was employed.

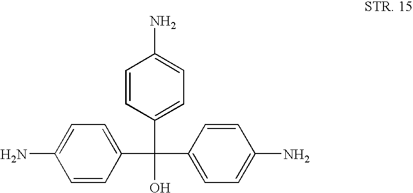

The gold layer was selectively removed from the areas of the substrate coated with the hexadecanethiol SAM template. The gold layer was partially etched from areas of the substrate covered by the molecular resist. The molecular resist composition comprising pararosaniline base (STR. 15) provided very good contrast, moderate substrate wetting, and good edge resolution.

### Example 16

Subtractive non-penetrating features were formed on a composite substrate as described in Example 1, except that a molecular resist composition comprising 0.07% by weight acid violet (sodium (Z)-3-(((4-((4-(diethylamino)phenyl)(4-(ethyl(3-sulfonatobenzyl)amino)phenyl)methylene)cyclohexa-2,5-dienylidene)(ethyl)ammonio)methyl)benzenesulfonate), STR. 16, in ethanol was employed

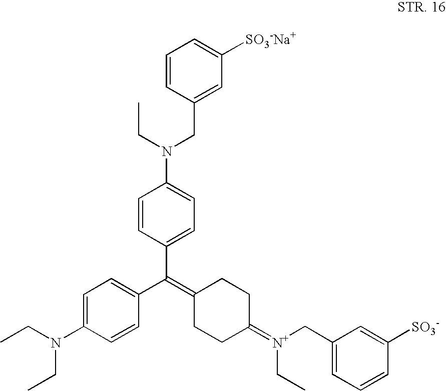

Areas of the substrate covered by the molecular resist were not etched and the gold remained on the surface in these areas. However, there were several areas in which the molecular resist did not completely de-wet the SAM. Thus, the molecular resist composition comprising acid violet (STR. 16) provided moderate contrast, good de-wetting and poor edge resolution.

### Example 17

Subtractive non-penetrating features were formed on a composite substrate as described in Example 1, except that a molecular resist composition comprising 0.07% by weight crystal violet lactone (6-(dimethylamino)-3,3-bis(4-(dimethylamino)phenyl)iso-benzofuran-1(3H)-one), STR. 17,

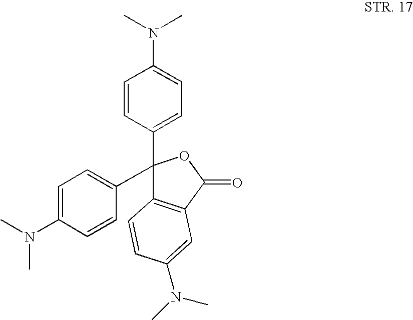

The gold layer was selectively removed from the areas of the substrate coated with the hexadecanethiol SAM template. The gold layer was not etched from areas of the substrate covered by the molecular resist. The molecular resist composition comprising crystal violet lactone (STR. 17) provided good contrast, good de-wetting and good edge resolution.

### Example 18

Subtractive non-penetrating features were formed on a composite substrate as described in Example 1, except that a molecular resist composition comprising 0.07% by weight triphenylamine, STR. 18, in ethanol was employed.

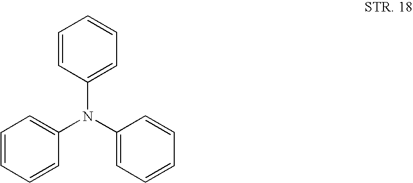

The gold layer was selectively removed from the areas of the substrate coated with the hexadecanethiol SAM template. The gold layer was not etched from areas of the substrate covered by the molecular resist. The molecular resist composition comprising triphenylamine (STR. 18) provided good contrast, good de-wetting and moderate edge-resolution.

### Comparative Example A

Subtractive non-penetrating features were formed on a composite substrate as described in Example 1, except that a molecular resist composition comprising 0.07% by weight anthracene, STR. A, in ethanol was employed.

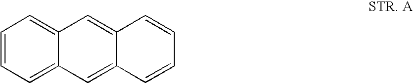

The gold layer was removed from the entire surface area of the substrate, including areas that were coated with the hexadecanethiol SAM, and those areas coated with the molecular resist. The molecular resist composition comprising anthracene, STR. A, provided moderate contrast, moderate template de-wetting, poor substrate wetting, and poor edge resolution.

### Comparative Example B

Subtractive non-penetrating features were formed on a composite substrate as described in Example 1, except that a molecular resist composition comprising 0.07% by weight pyrene, STR. B, in ethanol was employed.

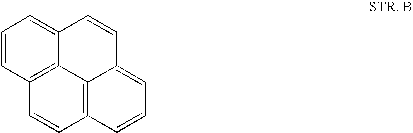

The gold layer was removed from the entire surface area of the substrate, including areas that were coated with the hexadecanethiol SAM and those areas coated with the molecular resist. Thus molecular resist composition comprising STR. B provided moderate contrast, poor template de-wetting, poor substrate wetting, and poor edge resolution.

### Comparative Example C

Subtractive non-penetrating features were formed on a composite substrate as described in Example 1, except that a molecular resist composition comprising 0.07% by weight perylene, STR. C, in ethanol was employed.

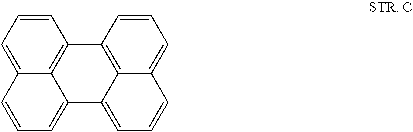

The gold layer was removed from the entire surface area of the substrate, including areas that were coated with the hexadecanethiol SAM and those areas coated with the molecular resist. Thus molecular resist composition comprising STR. C provided poor contrast. The other evaluation parameters were not observed.

### Comparative Example D

Subtractive non-penetrating features were formed on a composite substrate as described in Example 1, except that a molecular resist composition comprising 0.07% by weight cresol purple (ortho-creolsulfonphthalein), STR. D, in ethanol was employed.

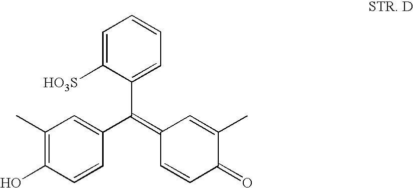

The gold layer was removed from the entire surface area of the substrate, including areas that were coated with the hexadecanethiol SAM, and those areas coated with the molecular resist. Thus molecular resist composition comprising STR. D provided poor contrast, poor template de-wetting, poor substrate wetting, and poor edge resolution.

The results from Examples 1-18 and Comparative Examples A-D are compiled in Table. 1. As described herein, “contrast” refers to the degree of etch resistance provided by the molecular resist, “de-wetting” refers to the extent to which the SAM pattern (i.e., the template) was de-wetted by the molecular resist, and “edge-resolution” refers to the ability of the molecular resist to protect against horizontal etching from the edges of the molecular resist pattern. These variables were rated on a scale of 1 to 5, with 5 being the highest performance.

TABLE 1
The process performance parameters (contrast, template de-wetting,
substrate wetting and edge resolution) from Examples 1-18 and
Comparative Examples A-D were rated on a scale of 1-5
(5 = best performance; 1 = lowest performance).

| | | Template | | |
|---|---|---|---|---|
| Example | Contrast | de-wetting | Substrate wetting | Edge resolution |
| 1 | 5 | 5 | 5 | 5 |
| 2 | 5 | 5 | 5 | 5 |
| 3 | 5 | 5 | 5 | 5 |
| 4 | 5 | 5 | 5 | 5 |
| 5 | 5 | 5 | 5 | 5 |
| 6 | 5 | 5 | 5 | 5 |
| 7 | 5 | 2 | 2 | 4 |
| 8 | 3 | 5 | 2 | 2 |
| 9 | 5 | 1 | 1 | 4 |
| 10 | 2 | 5 | 2 | 3 |
| 11 | 1 | n/a | n/a | n/a |
| 12 | 1 | n/a | n/a | n/a |
| 13 | 1 | n/a | n/a | n/a |
| 14 | 1 | n/a | n/a | n/a |
| 15 | 4 | 5 | 2 | 3 |
| 16 | 4 | 4 | 3 | 3 |
| 17 | 5 | 4 | 5 | 5 |
| 18 | 3 | 4 | 3 | 3 |
| A | 2 | 2 | 1 | 1 |
| B | 2 | 1 | 1 | 1 |
| C | 2 | n/a | n/a | n/a |
| D | 1 | 1 | 1 | 1 |

The results show that the molecular resist compositions of Examples 1-10 and 15-17 exhibited varying degrees of contrast, with the molecular resist compositions of Examples 1-7, 9, 15 and 17 providing superior contrast. The molecular resist compositions of Examples 1-6, 8, 10 and 15 provided superior template de-wetting. The molecular resist compositions of Examples 1-6 and 17 provided superior substrate wetting. The molecular resist compositions of Examples 1-6 and 17 provided superior edge resolution. The contrast provided by the molecular resist compositions of Examples 11-14 was poor, and the template de-wetting, substrate wetting and edge resolution of these molecular resists was not investigated.

### Example 19

An elastomeric stamp was prepared from PDMS using a master. The patterned PDMS stamp included a surface having a indentations therein that defined an array of circular protrusions having a lateral dimension of about 10 μm. The surface of the stamp was immersed in a monolayer-forming ink (a solution of 100 mM hexadecanethiol in acetone) for 15 seconds. The inked stamp was blown dry with nitrogen (15 seconds drying time), and the inked and dried surface of the stamp was applied to a composite substrate having a metal surface layer thereon (70 nm thick gold over poly(ethyleneterphthalate) “PET”, composite substrates available from, e.g., CP Films, Inc., Fieldale, Va.). The hexadecanethiol formed a primary pattern or “template” comprising a SAM on areas of the composite substrate that contacted the stamp surface. Circular areas on the substrate that corresponded to the pattern of protrusions were patterned with the SAM, while the areas surrounding the circular areas remained clean. A molecular resist composition of 0.07% by weight basic fuschin (4-(bis(4-aminophenyl)methylene)cyclohexa-2,5-dieniminium chloride), STR. 1 herein, in ethanol was then applied to the substrate by immersing the templated surface for 15 seconds in the molecular resist composition. The molecular resist composition initially coated the entire surface of the composite substrate.

The molecular resist was then dried for 1 minute on a hotplate set at 80° C. However, after several seconds, the molecular resist composition began to de-wet the templated areas of the substrate, and preferentially wet the metal areas of the substrate. Thus, the molecular resist coated the areas of the substrate not covered by the primary pattern comprising a SAM. The patterned substrate was reacted with a reactive composition by immersion in a KI/I₂-based etchant (i.e., TRANSENE® TFA gold etchant, Transene Co., Inc., Danvers, Mass.) solution for 11 seconds. The substrate was then rinsed with deionized water followed by ethanol, and then dried with dry nitrogen. The reaction produced subtractive penetrating features on the substrate corresponding to the pattern of indentations in the surface of the stamp (i.e., gold was selectively removed from only those areas of the substrate that were coated with the hexadecanethiol SAM template). Areas of the substrate covered by the molecular resist were not etched. As in Example 1, the molecular resist composition comprising basic fuschin (STR. 1) provided excellent contrast, excellent wetting and de-wetting and excellent edge resolution.

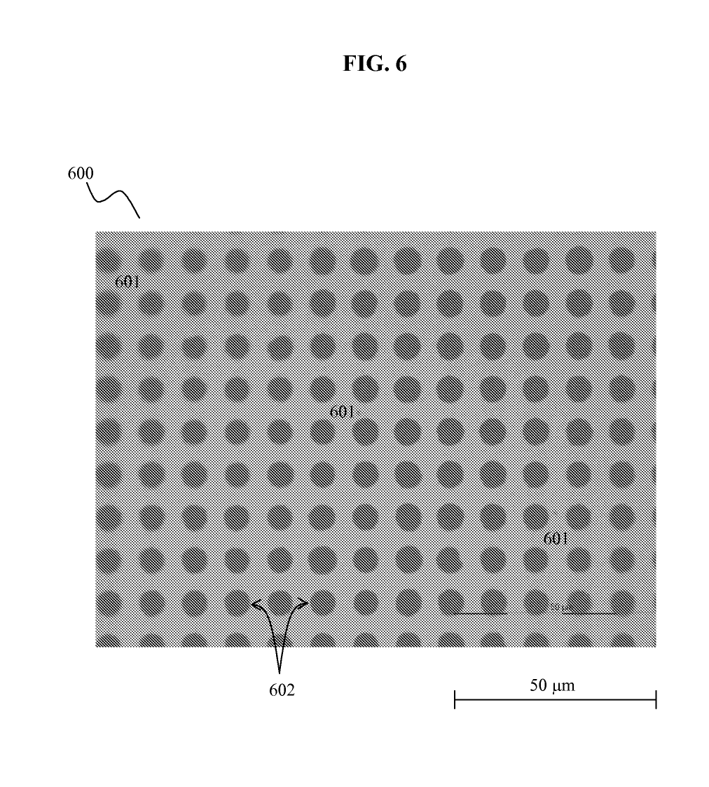

FIG. 6 provides a bright field optical microscope image of a portion of the substrate patterned using the procedure of Example 19. Referring to FIG. 6, an image, 600, show areas of the substrate, 601, that were protected by the molecular resist composition (i.e., the gold layer was not removed). The circular features, 602, are areas of the substrate from which the gold layer was removed.

### Example 20

Subtractive non-penetrating features were formed on a composite substrate as described in Example 19, except that a molecular resist composition comprising 0.07% by weight leuco crystal violet (4,4′,4″-methanetriyltris(N,N-dimethylaniline)), STR. 6 herein, in ethanol was employed.

The gold layer was selectively removed from the areas of the substrate coated with the hexadecanethiol SAM template. The gold layer was not etched from areas of the substrate covered by the molecular resist. The molecular resist composition comprising leuco crystal violet (STR. 7) provided excellent contrast, good de-wetting and good edge resolution.

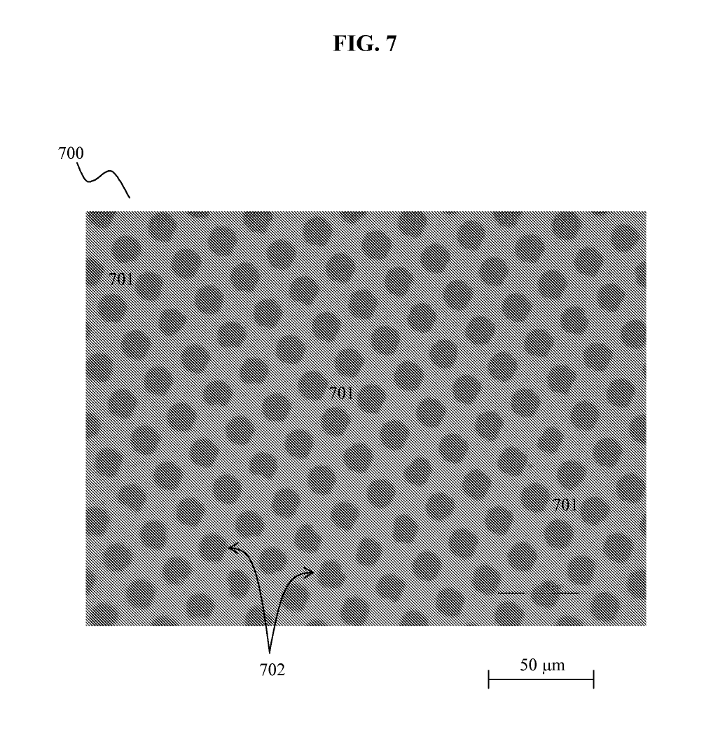

FIG. 7 provides a bright field optical microscope image of a portion of the substrate patterned using the procedure of Example 20. Referring to FIG. 7, an image, 700, show areas of the substrate, 701, that were protected by the molecular resist composition (i.e., the gold layer was not removed). The circular features, 702, are areas of the substrate from which the gold layer was removed. However, note that the features, 702, are not as well defined as those formed by the process of Example 19.

### Example 21

Subtractive non-penetrating features were formed on a composite substrate as described in Example 19, except that a molecular resist composition comprising 0.07% by weight celestine blue (N-(9-carbamoyl-6,7-dihydroxy-3H-phenoxazin-3-ylidene)-N-ethylethanaminium chloride), STR. 7 herein, in ethanol was employed.

The gold layer was selectively removed from the areas of the substrate coated with the hexadecanethiol SAM template. The gold layer was not etched from areas of the substrate covered by the molecular resist. The molecular resist composition comprising celestine blue (STR. 7) provided excellent contrast, good de-wetting and good edge resolution.

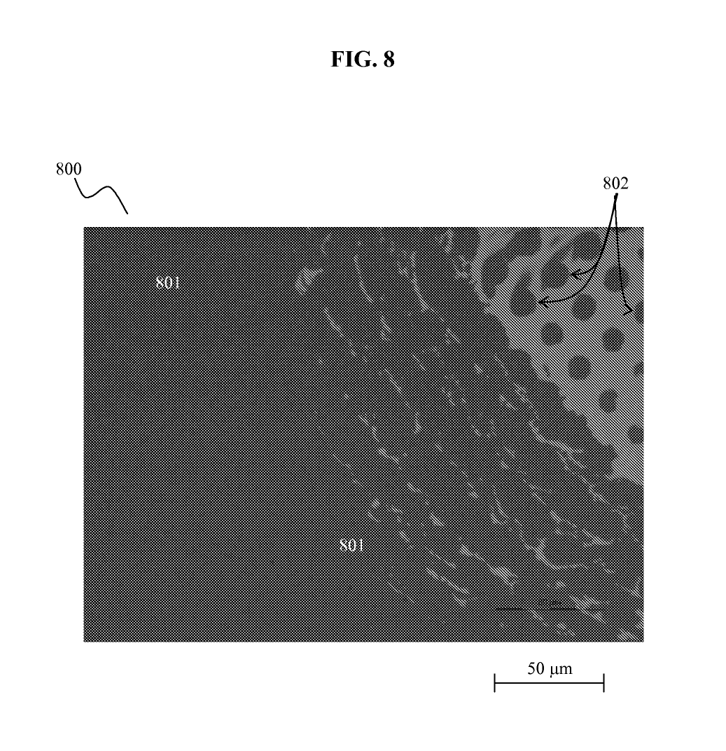

FIG. 8 provides a bright field optical microscope image of a portion of the substrate patterned using the procedure of Example 21. Referring to FIG. 8, an image, 800, show the substrate, 801, from which the gold layer has been almost completely removed. The circular features, 802, in the upper right-hand corner of the image were the only areas of the substrate that were protected by the molecular resist composition comprising STR. 7. This result is due largely to poor wetting of the substrate by the molecular resist composition.

### Example 22

Subtractive non-penetrating features were formed on a composite substrate as described in Example 19, except that a molecular resist composition comprising 0.07% by weight meldola's blue (N-(9H-benzo[a]phenoxazin-9-ylidene)-N-methylmethanaminium chloride), STR. 8 herein, in ethanol was employed.

The gold layer was selectively removed from the areas of the substrate coated with the hexadecanethiol SAM template. The gold layer was not etched from areas of the substrate covered by the molecular resist. The molecular resist composition comprising meldola's blue (STR. 8) good excellent contrast, good de-wetting and good edge resolution.

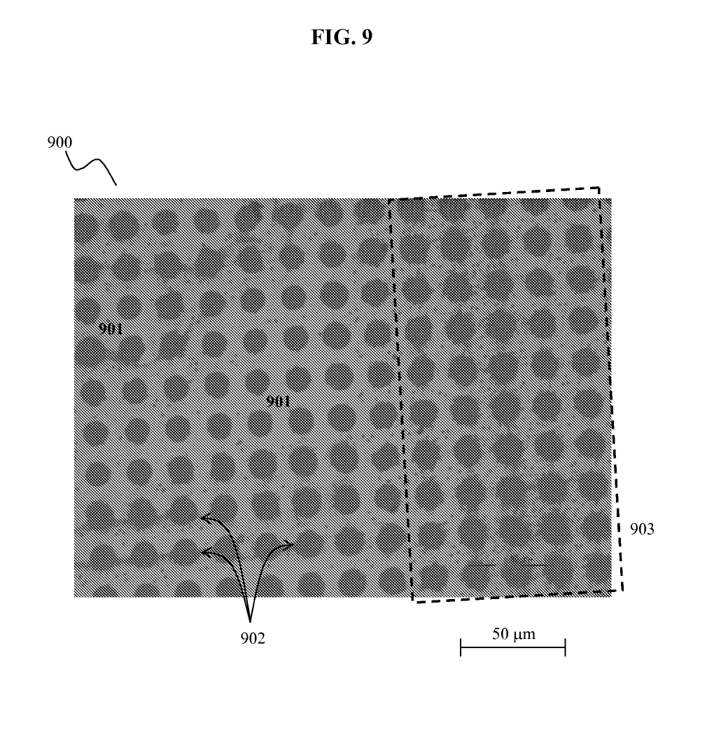

FIG. 9 provides a bright field optical microscope image of a portion of the substrate patterned using the procedure of Example 22. Referring to FIG. 9, an image, 900, show areas of the substrate, 901, that were protected by the molecular resist composition (i.e., the gold layer was not removed). The circular features, 902, are areas of the substrate from which the gold layer was removed. However, note that the features, 902, are not as well defined as those formed by the process of Example 19. Additionally, areas of the substrate, 901, are speckled with pinhole defects, 903, that arise from incomplete wetting of the substrate by the molecular resist. In some embodiments, the defect rate can be reduced by modifying the solvent properties of the molecular resist composition.

These exemplary embodiments described herein demonstrate that compared to SAM patterns, the molecular resist compositions of the present invention comprising an organic amine provide significantly enhanced etch resistance against KI/I₂ etchants. For example, in most of the exemplary embodiments described herein the SAM pattern was completely removed from the substrate by the etchant. On the other hand, the exemplary embodiments described herein demonstrate the formation of etch resistant patterns formed using molecular resist compositions that are substantially free from polymeric components, and are adhered to a substrate by a non-covalent interaction. The molecular resists compositions and patterns formed therefrom are significantly more resistant than SAMs to a wide variety of etchants, and can be patterned directly onto a substrate or using a pattern template such as a SAM.

### CONCLUSION

These examples illustrate possible embodiments of the present invention. While various embodiments of the present invention have been described above, it should be understood that they have been presented by way of example only, and not limitation. It will be apparent to a person skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method for patterning a substrate, the method comprising:
disposing on a substrate a molecular resist composition comprising an organic amine, wherein the organic amine adheres to the substrate by a non-covalent interaction in a pattern having at least one lateral dimension of about 500 μm or less; and
reacting a portion of the substrate not covered by the pattern to form a feature thereon, wherein the feature has a lateral dimension defined by the pattern.

2. The method of claim 1, further comprising prior to the disposing, forming a primary pattern on an area of the substrate, wherein the primary pattern defines the at least one lateral dimension of the pattern.

3. The method of claim 2, wherein the primary pattern comprises a self-assembled monolayer-forming species.

4. The method of claim 2, wherein the forming comprises contacting the substrate with a stamp having a surface including at least one indentation therein, and wherein the contacting transfers a self-assembled monolayer-forming species from the surface of the stamp to the substrate to form a primary pattern thereon having a lateral dimension defined by the at least one indentation.

5. The method of claim 1, wherein the reacting comprises etching.

6. The method of claim 1, wherein the pattern has an elevation of about 5 nm to about 5 μm.

7. The method of claim 1, wherein the molecular resist composition further comprises a solvent.

8. The method of claim 7, wherein the solvent comprises a first solvent having a boiling point less than 100° C. and at least one second solvent having a boiling point of 100° C. or greater.

9. The method of claim 1, wherein the substrate comprises a metal surface.

10. The method of claim 9, wherein the substrate is a composite substrate comprising a metal surface layer over a material chosen from: a glass, a plastic, a ceramic, a polymer, a second metal, and combinations thereof.

11. The method of claim 1, wherein the organic amine has a molar absorptivity of about 5,000 M⁻¹ cm⁻¹ or greater for at least one wavelength in the range of about 300 nm to about 900 nm.

12. The method of claim 1, wherein the molecular resist composition is free from any component having a molecular weight of about 2,000 Da or greater.

13. The method of claim 1, wherein the organic amine has the structure of Formula I:
A-(B)ₘ-C I
or a salt thereof, wherein:
A and C are independently chosen from: optionally substituted cycloalkyl, optionally substituted aryl, and optionally substituted heterocyclyl, or A and C are optionally joined to form a macrocyclic ring;
A and C each include at least one double bond;
B is an optionally substituted bridging group or a chemical bond;
m is an integer from 1 to 3, and
the organic amine of Formula I includes at least one amine group attached to at least one of A, B and C, or an optional substituent thereof.

14. The method of claim 1, wherein the organic amine has the structure of Formula II: 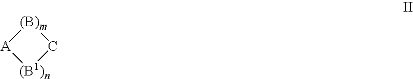
or a salt thereof, wherein:
A and C are independently chosen from: optionally substituted cycloalkyl, optionally substituted aryl, and optionally substituted heterocyclyl, or A and C are optionally joined to form a macrocyclic ring;
A and C each include at least one double bond;
B and B¹ are independently an optionally substituted bridging group or a chemical bond;
m and n are independently an integer from 1 to 3, and
the organic amine of Formula II includes at least one amine group attached to at least one of A, B, B¹ and C, or an optional substituent thereof.

15. The method of claim 1, wherein the organic amine has the structure of Formula V: 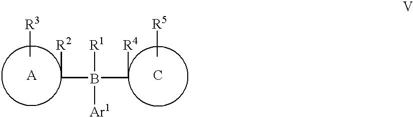
or a salt thereof, wherein:
ring systems A and C are independently a 4- to 14-membered ring system chosen from: optionally substituted cycloalkyl, optionally substituted aryl, and optionally substituted heterocyclyl;
B is an optionally substituted bridging group;
R¹ and R³ or R¹ and R⁵ are hydrogen or are optionally joined to form a 4- to 7-membered ring system chosen from: optionally substituted cycloalkyl, optionally substituted aryl, and optionally substituted heterocyclyl;
R¹ and R² or R¹ and R⁴ are independently hydrogen or are optionally joined to form a double bond, or R¹ is optionally absent;
R² is optionally joined with a member of ring A to form a double bond or a bridging group, or R² is optionally absent;
R⁴ is optionally joined with a member of ring C to form a double bond or a bridging group, or R⁴ is optionally absent;
Ar¹ is chosen from phenyl, naphthyl or aromatic heterocyclyl, any of which is optionally substituted; and
the organic amine of Formula V includes at least one amine group attached to at least one of Ar¹, R¹, R², R³, R⁴, R⁵, ring system A, ring system C, and B, or an optional substituent thereof

16. The method of claim 1, wherein the organic amine has the structure of Formula VI: 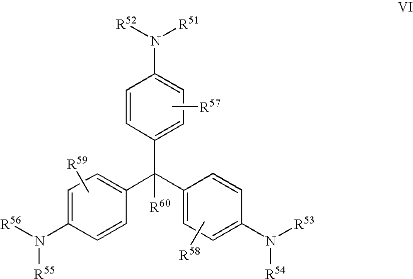
or a salt thereof, wherein:
R⁵¹, R⁵², R⁵³, R⁵⁴, R⁵⁵ and R⁵⁶ are independently hydrogen or C₁-C₄ alkyl;
R⁵⁷, R⁵⁸ and R⁵⁹ are independently hydrogen or methyl; and
R⁶⁰ is hydrogen or C₁-C₆ alkyl.

17. The method of claim 1, wherein the organic amine has the structure of Formula VII: 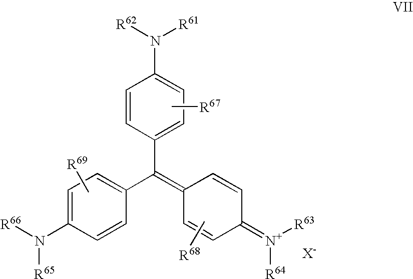
or a salt thereof, wherein:
R⁶¹, R⁶², R⁶³, R⁶⁴, R⁶⁵ and R⁶⁶ are independently hydrogen or C₁-C₄ alkyl;
R⁶⁷, R⁶⁸ and R⁶⁹ are independently hydrogen or methyl; and
X⁻ is a monovalent anion.

18. The method of claim 1, wherein the organic amine is a compound chosen from: acid blue 25, acid blue 29, acid blue 40, acid blue 45, acid blue 80, acid blue 92, acid blue 119, acid blue 120, acid blue 129, acid black 24, acid black 48, acid fuchsin, basic fuchsin, new fuchsin, acid green 25, acid green 27, acid orange 8, acid orange 51, acid orange 63, acid orange 74, acid red 1, acid red 4, acid red 8, acid red 37, acid red 88, acid red 97, acid red 114, acid red 151, acid red 183, acid red 183, methyl violet, methyl violet B, methyl violet 2B, ethyl violet, acid violet, acid violet 1, acid violet 5, acid violet 6, acid violet 7, acid violet 9, acid violet 17, acid violet 20, acid violet 30, acid violet 34, acid alizarin violet N, acid yellow 14, acid yellow 17, acid yellow 25, acid yellow 42, acid yellow 76, acid yellow 99, basic violet 1, basic violet 3, benzyl violet 4B, Coomassie® violet R^{200,} crystal violet, leucocrystal violet, resorcin crystal violet, crystal violet lactone, direct violet 17, direct violet 38, direct violet 51, fast violet B, gentian violet, pararosaniline base, cresolphthalein complexone, cresyl violet acetate, cresyl violet perchlorate, cresyl violet perchlorate, iodonitrotetrazolium violet-formazan, methylene violet 3RAX, pyoktanin blue, pyrocatechol violet, remazol brilliant violet 5R, rhodamine B, tetrazolium violet, violamine R, fast red violet 1B base, iodonitrotetrazolium chloride, leuco patent blue violet, thionin acetate, calcomine violet N, disperse violet 13, disperse violet 17, disperse violet 28, phenol violet, pontachrome violet SW, reactive violet 5, vat violet 1, wool violet, erio chrome violet 5B, omega chrome dark violet D, leucomalachite green, and salts and ionomers thereof, and combinations thereof.

19. A product prepared by the process of claim 1.

20. A method for patterning a substrate, the method comprising:
contacting a substrate with a stamp having a surface including at least one indentation therein to provide a first pattern on the substrate defined by the at least one indentation;
disposing on the substrate a molecular resist composition comprising an organic amine, wherein the organic amine adheres by a non-covalent interaction to an area of the substrate not covered by the first pattern; and
etching the area of the substrate covered by the first pattern to form a feature thereon.

21. A molecular resist composition consisting essentially of:
an organic amine in a concentration of about 0.01% to about 5% by weight;
a first solvent having a boiling point less than 100° C. in a concentration of about 80% by weight or greater;
at least one second solvent having a boiling point of 100° C. or greater in a concentration of about 15% by weight or less; and
an optional surfactant or stabilizer.

22. The molecular resist composition of claim 21, wherein the organic amine has a structure according to Formula I:
A-(B)ₘ-C I
or a salt thereof, wherein:
A and C are independently chosen from: optionally substituted cycloalkyl, optionally substituted aryl, and optionally substituted heterocyclyl, or A and C are optionally joined to form a macrocyclic ring;
A and C each include at least one double bond;
B is an optionally substituted bridging group or a chemical bond;
m is an integer from 1 to 3, and
the structure of Formula I includes at least one amine group attached to at least one of A, B and C, or an optional substituent thereof.

23. The molecular resist composition of claim 21, wherein the organic amine has a structure according to Formula V: 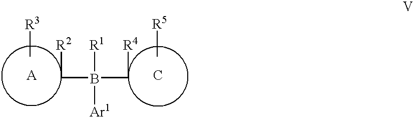
or a salt thereof, wherein:
ring systems A and C are independently a 4- to 14-membered ring system chosen from: optionally substituted cycloalkyl, optionally substituted aryl, and optionally substituted heterocyclyl;
B is an optionally substituted bridging group;
R¹ and R³ or R¹ and R⁵ are hydrogen or are optionally joined to form a 4- to 7-membered ring system chosen from: optionally substituted cycloalkyl, optionally substituted aryl, and optionally substituted heterocyclyl;
R¹ and R² or R and R⁴ are independently hydrogen or are optionally joined to form a double bond, or R¹ is optionally absent;
R² is optionally joined with a member of ring A to form a double bond or a bridging group, or R² is optionally absent;
R⁴ is optionally joined with a member of ring C to form a double bond or a bridging group, or R⁴ is optionally absent;
Ar¹ is chosen from phenyl, naphthyl or aromatic heterocyclyl, any of which is optionally substituted; and
the structure of Formula V includes at least one amine group attached to at least one of Ar¹, R¹, R², R³, R⁴, R⁵, ring system A, ring system C, and B, or an optional substituent thereof.

24. The molecular resist composition of claim 21, wherein the organic amine has the structure of Formula VI: 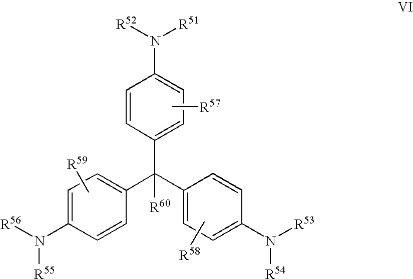
or a salt thereof, wherein:
R⁵¹, R⁵², R⁵³, R⁵⁴, R⁵⁵ and R⁵⁶ are independently hydrogen or C₁-C₄ alkyl;
R⁵⁷, R⁵⁸ and R⁵⁹ are independently hydrogen or methyl; and
R⁶⁹ is hydrogen or C₁-C₆ alkyl.

25. The molecular resist composition of claim 21, wherein the organic amine has the structure of Formula VII: 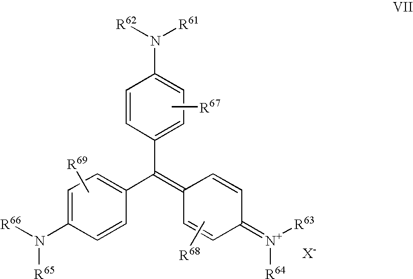
or a salt thereof, wherein:
R⁶¹, R⁶², R⁶³, R⁶⁴, R⁶⁵ and R⁶⁶ are independently hydrogen or C₁-C₄ alkyl;
R⁶⁷, R⁶⁸ and R⁶⁹ are independently hydrogen or methyl; and
X⁻ is a monovalent anion.

26. The molecular resist composition of claim 21, wherein the organic amine is a compound chosen from: acid blue 25, acid blue 29, acid blue 40, acid blue 45, acid blue 80, acid blue 92, acid blue 119, acid blue 120, acid blue 129, acid black 24, acid black 48, acid fuchsin, basic fuchsin, new fuchsin, acid green 25, acid green 27, acid orange 8, acid orange 51, acid orange 63, acid orange 74, acid red 1, acid red 4, acid red 8, acid red 37, acid red 88, acid red 97, acid red 114, acid red 151, acid red 183, acid red 183, methyl violet, methyl violet B, methyl violet 2B, ethyl violet, acid violet, acid violet 1, acid violet 5, acid violet 6, acid violet 7, acid violet 9, acid violet 17, acid violet 20, acid violet 30, acid violet 34, acid alizarin violet N, acid yellow 14, acid yellow 17, acid yellow 25, acid yellow 42, acid yellow 76, acid yellow 99, basic violet 1, basic violet 3, benzyl violet 4B, Coomassie® violet R^{200,} crystal violet, leucocrystal violet, resorcin crystal violet, crystal violet lactone, direct violet 17, direct violet 38, direct violet 51, fast violet B, gentian violet, pararosaniline base, cresolphthalein complexone, cresyl violet acetate, cresyl violet perchlorate, cresyl violet perchlorate, iodonitrotetrazolium violet-formazan, methylene violet 3RAX, pyoktanin blue, pyrocatechol violet, remazol brilliant violet 5R, rhodamine B, tetrazolium violet, violamine R, fast red violet 1B base, iodonitrotetrazolium chloride, leuco patent blue violet, thionin acetate, calcomine violet N, disperse violet 13, disperse violet 17, disperse violet 28, phenol violet, pontachrome violet SW, reactive violet 5, vat violet 1, wool violet, erio chrome violet 5B, omega chrome dark violet D, leucomalachite green, and salts and ionomers thereof, and combinations thereof.

27. A composition comprising: a substrate having a surface, and on the surface:
(a) a pattern comprising an organic amine, wherein the pattern has at least one lateral dimension of about 500 μm or less; and
(b) adjacent to the pattern, and covering the area of the surface not covered by the pattern, a thin film comprising a self-assembled monolayer-forming species.

28. A composition comprising: a substrate having a surface including at least one etched indentation therein, the etched indentation forming a pattern in the surface having at least one lateral dimension of about 500 μm or less, and having on the raised areas of the pattern a thin film comprising an organic amine adhered to the substrate by a non-covalent interaction, wherein the etched indentation is free from the organic amine.

29. The composition of claim 28, wherein the thin film comprising an organic amine has a thickness of about 5 nm to about 5 μm.

30. The composition of claim 28, wherein the thin film comprising an organic amine does not penetrate or permeate into the substrate.
